(19) United States
(12) Patent Application Publication
(10) Pub. No.: US 2007/0287032 A1
(43) Pub. Date: Dec. 13, 2007

(54) MAGNETIC RECORDING MEDIUM

(75) Inventors: Yoshihiro NAKAI, Odawara -shi (JP); Hiroshi Hashimoto, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/759,023

(22) Filed: Jun. 6, 2007

(30) Foreign Application Priority Data
Jun. 9, 2006 (JP) 2006-161250

(51) Int. Cl. G11B 5/716

(52) U.S. Cl. 428/840.1; 428/840.5

(57) ABSTRACT

A magnetic recording medium is provided that comprises a non-magnetic support and, in order thereabove, a radiation-cured layer (H) cured by exposing a layer comprising a conductive polymer (E) and a radiation curing monomer (C) to radiation, and a magnetic layer comprising a ferromagnetic powder dispersed in a binder.

### BACKGROUND OF THE INVENTION

1. Field of the Invention

The present invention relates to a magnetic recording medium.

### BACKGROUND ART

2. Description of the Related Art

Magnetic recording technology has the excellent features, not seen in other recording methods, that the medium can be used repeatedly, signals are easily converted to electronic form and it is possible to build a system in combination with peripheral equipment, and signals can easily be corrected, and is therefore widely used in various fields including video, audio, and computer applications.

As tape-form magnetic recording media for audio, video, and computers, and disc-form magnetic recording media such as flexible discs, a magnetic recording medium has been used in which a magnetic layer having dispersed in a binder a ferromagnetic powder such as γ-iron oxide, Co-containing iron oxide, chromium oxide, or a ferromagnetic metal powder is provided on a support. With regard to the support used in the magnetic recording medium, polyethylene terephthalate (PET), polyethylene naphthalate (PEN), etc. are generally used. Since these supports are drawn and are highly crystallized, their mechanical strength is high and their solvent resistance is excellent.

Since the magnetic layer, which is obtained by coating the support with a coating solution having the ferromagnetic powder dispersed in the binder, has a high degree of packing of the ferromagnetic powder, low elongation at break and is brittle, it is easily destroyed by the application of mechanical force and might peel off from the support. In order to prevent this, an undercoat layer is provided on the support so as to make the magnetic layer adhere strongly to the support.

Since accessing a magnetic recording medium involves reading and writing a signal by means of contact with a metallic magnetic head, adhesion of foreign matter such as dust to the surface of the recording medium is a main cause of fatal signal errors. Because of this, relatively high antistatic performance is normally required, with a surface resistance value at a level of 10⁶ to 10⁸ Ω.

With regard to the antistatic performance exhibited, conductivity is conventionally made to be exhibited by adding a conductive particulate substance such as carbon black, but in order for a desired antistatic performance (conductivity) to be exhibited it is necessary to add a large amount of conductive particulate substance to a non-magnetic layer. On the other hand, in order for superior electromagnetic conversion characteristics to be exhibited, it is necessary to smooth the surface of the magnetic recording medium to a high level, and there is a problem in controlling the dispersion state of the particulate substance. It is surmised that an improvement in the dispersibility of the conductive particles results in a decrease in the conductive path between the particles, this causes a decrease in conductivity, and there is a limit to improving both the surface smoothness and the conductivity. As a result, this limits the ability to obtain a magnetic recording medium having excellent electromagnetic conversion characteristics and error characteristics.

A magnetic recording medium to which a conductive polymer (E) is added is known (JP-A-60-035323, JP-A-03-016012, JP-A-04-324113, JP-A-05-189751, JP-A-05-189746, JP-A-05-242454, JP-A-05-282651, JP-A-05-290364, JP-A-06-119630 and JP-A-2003-141709, JP-A denotes a Japanese unexamined patent application). Magnetic recording media described in these publications comprise the conductive polymer (E) in any of the layers forming the magnetic recording media, but have any of the defects described below. That is, there are problems such as (1) the modulus of elasticity as a layer being degraded and problems in terms of the production process, (2) the level of surface smoothness required in recent years being unattainable, (3) poor transport durability, and (4) poor storage stability in high temperature and high humidity environments.

### BRIEF SUMMARY OF THE INVENTION

In the light of such problems, there have been proposed methods for forming a magnetic layer or a non-magnetic layer, or a layer that is independent from these layers, using a conductive polymer (E) as described above. All of these methods give a satisfactory surface resistance value, but the surface smoothness cannot reach the high level of smoothness that is an object of the present invention, and practical properties such as electromagnetic conversion characteristics, error characteristics, transport durability, and storage stability necessary for a magnetic recording medium are poor. This is because when the conductive polymer (E) is applied to the magnetic layer it greatly affects the dispersion state of the particulate magnetic substance, the conductive particles, etc., and when the conductive polymer (E) is used in a single layer the modulus of elasticity of the layer is inadequate, roll sticking occurs during the production process, and the above-mentioned practical properties are poor.

It is an object of the present invention to provide a magnetic recording medium that is excellent in terms of coating smoothness, a low surface resistance value, electromagnetic conversion characteristics, error characteristics, transport durability, and storage stability.

The object of the present invention has been accomplished by means of (1) below, which is described below together with (2) to (6), which are preferred embodiments.
(1) A magnetic recording medium comprising a non-magnetic support and, above the support, a radiation-cured layer (H) cured by exposing a layer comprising a conductive polymer (E) and a radiation curing monomer (C) to radiation,
(2) the magnetic recording medium according to (1), wherein it comprises a non-magnetic support and, in order thereabove, the radiation-cured layer (H) and a magnetic layer comprising a ferromagnetic powder dispersed in a binder,
(3) the magnetic recording medium according to (1), wherein it comprises a non-magnetic support and, in order thereabove, the radiation-cured layer (H), a non-magnetic layer comprising a non-magnetic powder dispersed in a binder, and a magnetic layer comprising a ferromagnetic powder dispersed in a binder,
(4) the magnetic recording medium according to any one of (1) to (3), wherein the conductive polymer (E) is a π-electron conjugated polymer,
(5) the magnetic recording medium according to any one of (1) to (4), wherein the layer comprising a conductive polymer (E) and a radiation curing monomer (C) is provided by coating with an organic solvent solution in which the radiation curing monomer (C) is dissolved and the conductive polymer (E), including a dopant, is dispersed, and
(6) the magnetic recording medium according to any one of (1) to (5), wherein the radiation-cured layer (H) has an average thickness of 0.1 to 1.5 μm.

### DETAILED DESCRIPTION OF THE INVENTION

The magnetic recording medium of the present invention comprises, in order, a radiation-cured layer (H) cured by exposing to radiation a layer comprising a conductive polymer (E) and a radiation curing monomer (C), and a magnetic layer comprising a ferromagnetic powder dispersed in a binder.

Furthermore, another aspect of the present invention relates to a production process for a magnetic recording medium, the production process comprising a step of preparing a radiation-cured layer composition comprising a conductive polymer (E) and a radiation curing monomer (C), a step of coating a non-magnetic support with the composition, a step of obtaining a radiation-cured layer by exposing the coated composition to radiation, and a step of coating the radiation-cured layer with a magnetic layer comprising a ferromagnetic powder dispersed in a binder. The radiation curing monomer is preferably an ethylenically unsaturated monomer. The conductive polymer (E) is preferably a π-electron conjugated polymer, and more preferably comprises a dopant. Furthermore, the exposure to radiation is preferably exposure to an electron beam.

The present invention is explained in detail below.

### I. Radiation-Cured Layer (H)

The radiation-cured layer (H) of the magnetic recording medium of the present invention is formed by curing a layer comprising a conductive polymer (E) and a radiation curing monomer (C) by exposure to radiation. The radiation-cured layer (H) is preferably a layer that is cured by exposing to radiation a layer containing no binder and substantially comprising the conductive polymer (E) and the radiation curing monomer (C).

The present inventors have found that adding the conductive polymer (E) to the radiation-cured layer (H) enables a very smooth coating to be obtained without greatly reducing the modulus of elasticity of the layer compared with a case in which a layer is formed using the conductive polymer (E) on its own, thus giving a magnetic recording medium having excellent practical properties such as electromagnetic conversion characteristics, error characteristics, transport durability, and storage stability. Particularly surprisingly, even when the amount of conductive polymer (E) added is small, the surface resistance value of the radiation-cured layer (H) and the surface resistance value of the magnetic recording medium can be made very low, and as a result the error characteristics are improved. It is surmised that this is because curing the radiation curing monomer (C) in the presence of the conductive polymer (E) can compensate for defects caused when the conductive polymer (E) is used on its own whereas the conductive polymer (E) forms conductive paths that exhibit high conductivity characteristics. It is thereby possible to design a magnetic recording material having both excellent surface smoothness and high conductivity characteristics while reducing the amount of conductive particles (carbon black, etc.), which are conventionally used in order for conductive characteristics to be exhibited, or ultimately not using them.

It is also an important point that, due to the use of a radiation-cured layer (H) comprising a conductive polymer, edge damage under severe transport conditions is improved by reducing or eliminating the thickness of an antistatic layer, which has conventionally been achieved by a non-magnetic (intermediate) layer comprising conductive particles such as carbon black. Furthermore, in terms of the design of the magnetic recording medium, it becomes possible as a secondary effect to provide a magnetic recording medium having excellent strength and durability by increasing the thickness of a support mainly comprising a polyester. For identical thicknesses of support, the thickness of the tape can be made small, and it becomes possible to provide a magnetic recording medium having a long wound length per reel and consequently a large memory capacity per reel, thus from another viewpoint giving the effect that the degree of freedom in design increases greatly.

### 1. Conductive Polymer (E)

### (1) Conductive Polymer (E)

The conductive polymer (E) used in the present invention is not particularly limited as long as it is a known polymer material that can exhibit high conductivity, but it is preferably a π-electron conjugated polymer. The ‘π-electron conjugated polymer’ referred to here means a polymer having a structure in which π electrons in the polymer main chain are conjugated. It is preferable to combine the conductive polymer (E) with an electron acceptor or an electron donor, which is called a dopant, thus enhancing the conductivity of the conductive polymer (E).

Examples of the conductive polymer (E) that can be used in the present invention include polythiophene, polypyrrole, polyaniline, polyfuran, polyacetylene, poly(p-phenylene), poly(p-phenylenesulfide), and derivatives thereof, and among them polythiophene, polypyrrole, polyaniline, and derivatives thereof are preferable.

Examples of the conductive polymer (E) that can be used in the magnetic recording medium of the present invention include polymers comprising as a constituent unit one or more types of monomer selected from the group consisting of thiophene, a 3-alkylthiophene such as 3-methylthiophene, 3-octylthiophene, or 3-dodecylthiophene, a 3-alkoxythiophene such as 3-methoxythiophene, a 3,4-dialkylthiophene such as 3,4-dimethylthiophene, 3,4-ethylenedioxythiophene, terthiophene, 2,5-bipyrrolylthiophene, pyrrole, N-methylpyrrole, N-ethylpyrrole, N-n-propylpyrrole, N-n-butylpyrrole, N-phenylpyrrole, 3-methylpyrrole, 3-ethylpyrrole, 3-n-propylpyrrole, 3-n-butylpyrrole, 3-n-octylpyrrole, bipyrrole, terpyrrole, methyl 3-methyl-4-pyrrolecarboxylate, butyl 3-methyl-4-pyrrolecarboxylate, 2,5′-biphenylterpyrrole, 2,5′-bithienylbipyrrole, p,p′-bipyrrolylbenzene, p-phenylene, phenylene vinylene, isothianaphthene, trans-bithienylethylene, trans-bithienyl-1,4-butadiene, aniline, anisidine, an N-alkylaniline such as N-methylaniline, p-phenylenediamine, m-phenylenediamine, furan, and a substituted furan.

Among the above-mentioned compound examples, from the viewpoint of high solubility in an organic solvent and the resulting radiation-cured layer (H) having excellent mechanical strength and thermal stability, it is preferable to use a polymer comprising as a constituent unit one or more types of monomer selected from the group consisting of 3-octylthiophene, 3-dodecylthiophene, 3,4-ethylenedioxythiophene, 3-octylpyrrole, methyl 3-methyl-4-pyrrolecarboxylate, aniline, and an N-substituted aniline. Yet more preferred examples of the conductive polymer (E) include poly(3,4-ethylenedioxythiophene), poly(methyl 3-methyl-4-pyrrolecarboxylate), and polyaniline.

### (2) Production Process

A process for producing the conductive polymer (E) used in the present invention is not particularly limited, and it can be obtained by dissolving the above-mentioned starting monomer for the conductive polymer (E) in a solvent together with an oxidizing agent and carrying out oxidative polymerization, or by electrochemically electropolymerizing the monomer. For example, an oxidizing agent that can be used in the oxidative polymerization is not particularly limited as long as it can polymerize the above-mentioned monomer or a derivative thereof, which is a starting material for the conductive polymer (E), and preferred examples thereof include ammonium persulfate, persulfuric acid, persulfates such as sodium persulfate and potassium persulfate, hydrogen peroxide, ferric chloride, ferric sulfate, potassium dichromate, potassium permanganate, and a hydrogen peroxide-ferrous salt redox initiator. These oxidizing agents may be used singly or in a combination of two or more types. The amount of oxidizing agent used is not particularly limited as long as it is an amount that enables oxidative polymerization to take place of the above-mentioned monomer or a derivative thereof, which is a starting material for the conductive polymer (E), and it is preferably 0.01 mol to 10 mol relative to 1 mole of the monomer or derivative thereof, and more preferably 0.1 mol to 5 mol.

### (3) Molecular Weight

The molecular weight of the conductive polymer (E) used is not particularly limited, but in order to obtain good mechanical strength and thermal stability for a resulting radiation-cured layer (H) or the magnetic recording medium that is the object of the present invention, it is preferably 1,000 to 1,000,000 as an average molecular weight on a polystyrene mass basis, and more preferably 2,000 to 800,000. When the molecular weight is in the above-mentioned range, since the n electron conjugated system is appropriate, the conductivity and the solubility in an organic solvent are excellent.

### (4) Dopant

In the magnetic recording medium of the present invention, in order for the conductive polymer (E) to exhibit higher conductivity, a doping agent, called a dopant, may be used in combination therewith. The type of dopant is not particularly limited, and it may be selected appropriately according to the type and structure of the conductive polymer (E) used. For example, when the conductive polymer (E) is polypyrrole or a polypyrrole derivative, examples of the dopant include 2,3-dichloro-5,6-dicyano-1,4-benzoquinone (DDQ), 7,7,8,8-tetracyanoquinodimethane (TCNQ), tetracyanoethylene (TCNE), chloranil, tetrafluorotetracyanoquinodimethane (TF-TCNQ), a DAMN derivative (tetracyanopyrazine, tetracyanotetraazanaphthalene, etc.), p-toluenesulfonic acid, dodecylbenzenesulfonic acid, and polystyrenesulfonic acid. They form a charge transfer complex with the polypyrrole or polypyrrole derivative, and high conductivity is shown.

Furthermore, when polyaniline, a polyaniline derivative, polythiophene, or a polythiophene derivative is used as the conductive polymer (E), examples of the dopant include inorganic acids such as sulfuric acid, nitric acid, hydrochloric acid, perchloric acid, hydrofluoric acid, and phosphoric acid, organic acids such as oxalic acid, formic acid, acetic acid, acrylic acid, methacrylic acid, benzenesulfonic acid, p-toluenesulfonic acid, trifluoroacetic acid, p-dodecylbenzenesulfonic acid, n-dodecylbenzenesulfonic acid, picric acid, m-nitrobenzoic acid, dichloroacetic acid, an alkylsulfonic acid, an alkyl-substituted naphthalenesulfonic acid, (±)-camphor-10-sulfonic acid, and an alkyl phosphate, and polymeric acids such as polystyrenesulfonic acid, polyacrylic acid, polymethacrylic acid, polyvinylsulfonic acid, polyallylsulfonic acid, and polyphosphoric acid. These dopants form a salt, called an emeraldine salt, with the polyaniline or polyaniline derivative, and high conductivity is shown.

The amount of dopant used is not particularly limited; it depends on the type of conductive polymer (E) or dopant selected, and is preferably 5 to 600 parts by weight relative to 100 parts by weight of the conductive polymer (E), and more preferably 10 to 300 parts by weight. When the amount of dopant used is in the above-mentioned range, excellent conductivity is obtained.

### (5) Organic Solvent

An organic solvent that can be used for providing the radiation-cured layer (H) by coating is not particularly limited as long as it can dissolve or disperse the conductive polymer (E), including the dopant, and the radiation curing monomer (C), and examples thereof include ketones such as acetone, methyl ethyl ketone, diethyl ketone, cyclopentanone, cyclohexane, cyclohexanone, methyl isobutyl ketone, and methyl n-propyl ketone, alcohols such as methanol, ethanol, ethyl CELLOSOLVE, 1-propanol, isopropyl alcohol, n-butanol, s-butanol, t-butanol, n-amyl alcohol, s-amyl alcohol, t-amyl alcohol, allyl alcohol, isoamyl alcohol, isobutyl alcohol, 2-ethylbutanol, 2-octanol, n-octanol, cyclohexanol, tetrahydrofurfuryl alcohol, furfuryl alcohol, n-hexanol, n-heptanol, 2-heptanol, 3-heptanol, benzyl alcohol, methylcyclohexanol, ethylene glycol, ethylene glycol monomethyl ether, glycerol, diethylene glycol, propylene carbonate, and propylene glycol, esters such as ethyl acetoacetate, ethyl benzoate, methyl benzoate, isobutyl formate, ethyl formate, propyl formate, methyl formate, isobutyl acetate, ethyl acetate, propyl acetate, methyl acetate, methyl salicylate, diethyl oxalate, diethyl tartarate, dibutyl tartarate, ethyl phthalate, methyl phthalate, butyl phthalate, γ-butyrolactone, ethyl malonate, and methyl malonate, N,N-dimethylformamide, N-methyl-2-pyrrolidone, benzene, toluene, xylene, m-cresol, dioxane, and tetrahydrofuran.

Among the above-mentioned organic solvents, from the viewpoint of the conductive polymer (E), including a dopant, and the radiation curing monomer (C) being dissolved or dispersed well, methyl ethyl ketone, cyclohexane, N-methyl-2-pyrrolidone, and toluene are preferable.

### (6) Proportion of Conductive Polymer (E) Used

The amount of conductive polymer (E), including dopant, used is preferably 1 to 80 parts by weight in 100 parts by weight of the solids content of the radiation-cured layer (H), more preferably 2 to 70 parts by weight, and yet more preferably 5 to 50 parts by weight. When the conductive polymer (E) is in the above-mentioned range, a radiation-cured layer (H) having an appropriate surface resistance value and an appropriate modulus of elasticity is obtained, and head contamination after transport or storage can be reduced.

### 2. Radiation Curing Monomer (C)

### (1) Radiation Curing Monomer (C)

In the present invention, the radiation curing monomer (C) is a low molecular weight compound that cures upon exposure to radiation such as UV rays or an electron beam. The radiation curing monomer (C) is thermally stable in a state in which it is not exposed to radiation. Because of this, a coating solution containing the conductive polymer (E) and the radiation curing monomer (C) has appropriate viscosity when a coating solvent evaporates on a non-magnetic support, exhibits an effect in burying micro projections on the non-magnetic support, and can give high coating smoothness by curing. That is, the radiation-cured layer (H) of the present invention plays a role as a smoothing layer.

Furthermore, the structure of the radiation curing monomer (C) used in the radiation-cured layer (H) is not particularly limited, but it is desirably a polyfunctional monomer containing at least 2 crosslinking functional groups per molecule in order for scratch resistance to be imparted to the layer surface and for an effect in protecting the surface of the support to be exhibited. The radiation-cured smoothing layer can be given high coating strength due to a three-dimensional crosslinking reaction when a polyfunctional monomer is used. As the polyfunctional monomer, at least one monomer or a monomer mixture selected from the group consisting of radically polymerizable monomers and cationically polymerizable monomers is preferable

### (2) Radically Polymerizable Monomer

As the radically polymerizable monomer that can be used in the present invention, one type or two or more types of (meth)acrylates (here, ‘(meth)acrylate’ means both acrylate and methacrylate; this applies below) may be appropriately selected and used. For example, there are (meth)acrylate compounds obtained by reacting a polyhydric alcohol with a compound having a radiation curing functional group and a carboxylic acid represented by acrylic acid or methacrylic acid, and urethane acrylates obtained by reacting a polyhydric alcohol with a compound having a radiation curing functional group and a group that reacts with a hydroxyl group, represented by 2-isocyanatoethyl acrylate or 2-isocyanatoethyl methacrylate. There are also those obtained by reacting a diisocyanate compound or an isocyanate terminal prepolymer with a compound having a radiation curing functional group and a group that reacts with an isocyanate group, represented by hydroxyethyl (meth)acrylate or hydroxybutyl (meth)acrylate. As the polyhydric alcohol, in addition to diols used as conventionally known polyurethane starting materials, polyester polyols, polyether polyols, polycarbonate polyols, polyolefin polyols, and polyether ester polyols may be used. As the diisocyanate compound, a known starting material for a polyurethane may be used.

Examples of polyfunctional (meth)acrylates containing cross linking functional groups that can be used in the present invention include, as difunctional compounds, 1,3-butanediol di(meth)acrylate, 1,4-butanediol di(meth)acrylate, 1,6-hexanediol di(meth)acrylate, diethylene glycol di(meth)acrylate, polyethylene glycol di(meth)acrylate, neopentyl glycol di(meth)acrylate, and cyclopentadienyl alcohol di(meth)acrylate.

Examples of tri- or higher-functional polyfunctional (meth)acrylates include trimethylolpropane tri(meth)acrylate, trimethylolethane tri(meth)acrylate, ditrimethylolpropane tetra(meth)acrylate, glycerol tri(meth)acrylate, pentaerythritol tri (meth)acrylate, pentaerythritol tetra(meth)acrylate, dipentaerythritol penta(meth)acrylate, dipentaerythritol hexa(meth)acrylate, and ethylene oxide- or propylene oxide-modified products thereof.

Examples of (meth)acrylates other than the above polyfunctional esters include polyester poly(meth)acrylates, epoxy (meth)acrylates, urethane poly(meth)acrylates, polysiloxane poly(meth)acrylates, and polyamide poly(meth) acrylates.

Among them, a preferred radically polymerizable monomer (C) is a di- or higher-functional polyfunctional monomer, and as a functional group an acryloyl group is preferred to a methacryloyl group since the polymerizability is excellent.

Furthermore, as the radically polymerizable monomer (C), an aliphatic diacrylate and an alicyclic diacrylate are preferable since a resulting magnetic recording medium has an excellent balance between mechanical strength and hygroscopicity.

Preferred examples of the aliphatic diacrylate include hexamethylenediol diacrylate, 2-ethyl-2-butyl-1,3-propanediol diacrylate, 3-methylpentanediol diacrylate, 2-methyloctanediol diacrylate, nonanediol diacrylate, neopentylglycol hydroxypivalate diacrylate, and a urethane diacrylate of trimethylhexamethylene diisocyanate. Among them, from the viewpoint of a resulting radiation-cured layer having excellent smoothness, those having a branched side chain are preferable, and 2-ethyl-2-butyl-1,3-propanediol diacrylate, 3-methylpentanediol diacrylate, 2-methyloctanediol diacrylate, neopentylglycol hydroxypivalate diacrylate, and a urethane diacrylate of trimethylhexamethylene diisocyanate are more preferable.

Preferred examples of the alicyclic diacrylate include cyclohexanedimethanol diacrylate, limonene alcohol diacrylate, tricyclodecanedimethanol diacrylate, dimer diol diacrylate, 5-ethyl-2-(2-hydroxy-1,1′-dimethylethyl)-5-(hydroxymethyl)-1,3-dioxane diacrylate, tetrahydrofurandimethanol diacrylate, and 3,9-bis(1,1-dimethyl-2-hydroxyethyl)-2,4,8,10-tetraoxaspiro[5.5]undecane diacrylate. Among them, tricyclodecanedimethanol diacrylate is preferable.

Examples of (meth)acrylates other than the above polyfunctional esters include epoxy (meth)acrylates, polysiloxane poly(meth)acrylates, and polyamide poly(meth)acrylates.

Furthermore, for reasons of adjusting viscosity, improving adhesion to a substrate, etc., a monofunctional (meth)acrylate may be added as necessary. Examples of such a monofunctional (meth)acrylate include 2-hydroxyethyl (meth)acrylate, 2-hydroxypropyl (meth)acrylate, 3-hydroxybutyl (meth)acrylate, 4-hydroxybutyl (meth)acrylate, 2-hyd roxypentyl (meth)acrylate, 4-hyd roxypentyl (meth)acrylate, 2-ethylhexyl (meth)acrylate, ethoxyethyl (meth)acrylate, N-hydroxymethyl (meth)acrylamide, and N-methoxymethyl (meth)acrylamide. The amount of these monofunctional (meth)acrylates used is preferably 0 to 40 parts by weight relative to 100 parts by weight of the solids content of the radiation-cured layer, and more preferably 0 to 30 wt % when scratch resistance, etc. are taken into account.

The radiation curing monomer preferably has a molecular weight of 300 to 5,000. It is preferable for it to be in the above-mentioned range since unreacted radiation curing monomer (C) does not precipitate in the radiation-cured layer (H) or on the surface of the magnetic recording medium, and the viscosity of the coating solution is appropriate, thereby giving a radiation-cured layer having excellent smoothness.

In the present invention, it is also preferable to add a chain transfer agent to a layer comprising the conductive polymer (E) and the radiation curing monomer (C), and to cure the radiation-cured layer (H) by exposure to radiation. Use of a chain transfer agent enables the amount of unreacted monomer remaining in the radiation-cured layer (H) to be reduced. The chain transfer agent that can be used in the present invention is preferably a compound having a large chain transfer coefficient; examples thereof include a thiol-containing compound, preferably a polyfunctional thiol having at least 2 thiol groups per molecule, and a disulfide group-containing compound having an —S—S— bond.

The amount of chain transfer agent added is preferably 2 to 60 wt % relative to the total weight of the radiation-cured layer (H), and more preferably 3 to 40 wt %.

As a photopolymerization initiator used for UV curing, a radical photopolymerization initiator is used. More particularly, those described in, for example, ‘Shinkobunshi Jikkenngaku’ (New Polymer Experiments), Vol. 2, Chapter 6 Photo/Radiation Polymerization (Published by Kyoritsu Publishing, 1995, Ed. by the Society of Polymer Science, Japan) can be used. Specific examples thereof include acetophenone, benzophenone, anthraquinone, benzoin ethyl ether, benzil methyl ketal, benzil ethyl ketal, benzoin isobutyl ketone, hydroxydimethyl phenyl ketone, 1-hydroxycyclohexyl phenyl ketone, and 2,2-diethoxyacetophenone. The mixing ratio of the photopolymerization initiator is preferably 0.5 to 20 parts by weight relative to 100 parts by weight of the radiation curing compound, more preferably 2 to 15 parts by weight, and yet more preferably 3 to 10 parts by weight.

### (3) Cationically Polymerizable Monomer

The cationically polymerizable monomer is not particularly limited, but is preferably one having at least one reactive group selected from a cyclic ether group and a vinyl ether group. The cationically polymerizable monomer preferably has at least 2 reactive groups per molecule, and more preferably at least three reactive groups, in order for sufficient hardness as the radiation-cured layer (H) to be obtained by irradiation with actinic radiation or by heating.

Among such cationically polymerizable monomers, examples of the compound having a cyclic ether group include compounds having an epoxy group, an alicyclic epoxy group, or an oxetanyl group. Specific examples of the compound having an epoxy group include bisphenol A diglycidyl ether, novolac epoxy resins, trisphenolmethane triglycidyl ether, 1,4-butanediol diglycidyl ether, 1,6-hexanediol diglycidyl ether, glycerol triglycidyl ether, trimethylolpropane triglycidyl ether, and propylene glycol diglycidyl ether.

Specific examples of the compound having an alicyclic epoxy group include 2,4-epoxycyclohexylmethyl 3,4-epoxycyclohexanecarboxylate, bis(3,4-epoxycyclohexylmethyl) adipate, 2-(3,4-epoxycyclohexyl-5,5-spiro-3,4-epoxy)cyclohexanone-meta-dioxane, bis(2,3-epoxycyclopentyl) ether, and EHPE-3150 (an alicyclic epoxy resin manufactured by Daicel Chemical Industries, Ltd.).

Specific examples of the compound having an oxetanyl group include 1,4-bis[(3-ethyl-3-oxetanylmethoxy) methyl]benzene, 1,3-bis[(3-ethyl-3-oxetanylmethoxy)methyl]propane, ethylene glycol bis(3-ethyl-3-oxetanylmethyl) ether, trimethylolpropane tris(3-ethyl-3-oxetanylmethyl) ether, pentaerythritol tetrakis(3-ethyl-3-oxetanylmethyl) ether, dipentaerythritol hexakis(3-ethyl-3-oxetanylmethyl) ether, and ethylene oxide-modified bisphenol A bis(3-ethyl-3-oxetanylmethyl) ether.

Among the cationically polymerizable monomers, specific examples of the compound having a vinyl ether group include triethylene glycol divinyl ether, tetraethylene glycol divinyl ether, trimethylolpropane trivinyl ether, cyclohexane-1,4-dimethylol divinyl ether, 1,4-butanediol divinyl ether, polyester divinyl ether, and polyurethane polyvinyl ether.

When a cationically polymerizable monomer is used, the composition of the radiation-cured layer (H) preferably comprises a known cationic photoinitiator or cationic thermopolymerization curing agent. When it contains a cationic photoinitiator, the cationically polymerizable monomer cures upon exposure to actinic radiation (cationic photopolymerization curing). When it contains a cationic thermopolymerization curing agent, the cationically polymerizable monomer cures upon heating (cationic thermopolymerization curing).

As the cationic photoinitiator, for example, an onium salt such as a diazonium salt, a sulfonium salt, or an iodonium salt may be used, and an aromatic onium salt is particularly preferably used. Other than the above, an iron-arene complex such as a ferrocene derivative, an arylsilanol-aluminum complex, etc. may preferably be used, and selection may appropriately be made therefrom. The content of the cationic photoinitiator is, for example, on the order of 0.5 to 5 parts by weight in a monomer or a monomer mixture forming the radiation-cured layer (H) (as solids content).

### (4) Exposure to Radiation

Examples of radiation used in the present invention include an electron beam and UV rays.

When ultraviolet rays are used, it is necessary to add a photopolymerization initiator to the above-mentioned compound. In the case of curing with an electron beam, no polymerization initiator is required, and the electron beam has a deep penetration depth, which is preferable.

With regard to electron beam accelerators that can be used here, there are a scanning system, a double scanning system, and a curtain beam system, and the curtain beam system is preferable since it is relatively inexpensive and gives a high output. With regard to electron beam characteristics, the acceleration voltage is 30 to 1,000 kV, and preferably 50 to 300 kV. The absorbed dose is 5 to 200 kGy (5 to 20 Mrad), and preferably 20 to 100 kGy (2 to 10 Mrad). When the acceleration voltage and the absorbed dose are in the above-mentioned ranges, a sufficient amount of energy penetrates and the energy efficiency is good. The atmosphere under which an electron beam is applied is preferably controlled so as to have an oxygen concentration of 200 ppm or less by purging with nitrogen, and in this range cross-linking and curing reactions in the vicinity of the surface proceed well.

As a light source for the ultraviolet rays, a mercury lamp is used. The mercury lamp is a 20 to 240 W/cm² lamp and is used at a speed of 0.3 to 20 m/min. The distance between a substrate and the mercury lamp is generally preferably 1 to 30 cm.

With regard to the radiation-curing equipment, conditions, etc., known equipment and conditions described in ‘UV.EB Kokagijutsu’ (UV/EB Radiation Curing Technology) (published by the Sogo Gijutsu Center), ‘Teienerugi Denshisenshosha no Oyogijutsu’ (Application of Low-energy Electron Beam) (2000, Published by CMC), etc. can be employed.

### (5) Thickness of the Radiation-Cured Layer

With regard to the constitution of the magnetic recording medium used in the present invention, the radiation-cured layer preferably has a thickness of 0.1 to 1.5 μm, more preferably 0.1 to 1.4 μm, and yet more preferably 0.2 to 1.0 μm. When the thickness is in the above-mentioned range, a magnetic recording medium having excellent smoothness (reduced Ra) and good adhesion to a non-magnetic support can be obtained.

### II. Magnetic Layer

The magnetic recording medium of the present invention comprises, above a non-magnetic support, a magnetic layer having a ferromagnetic powder dispersed in a binder.

### 1. Ferromagnetic Powder

It is preferable for the magnetic recording medium of the present invention to employ as a ferromagnetic powder an acicular ferromagnetic substance, a tabular magnetic substance, or a spherical or ellipsoidal magnetic substance. Each thereof is explained below.

### (1) Acicular Magnetic Substance

An acicular magnetic substance can be used as a ferromagnetic metal powder used in the magnetic recording medium of the present invention. Specifically an acicular cobalt-containing ferromagnetic iron oxide and ferromagnetic alloy powder, etc. can be cited. The specific surface area measured by the BET method (S_{BET}) is preferably 40 to 80 m²/g, and more preferably 50 to 70 m²/g. The crystallite size is preferably 12 to 25 nm, more preferably 13 to 22 nm, and particularly preferably 14 to 20 nm. The length of the major axis is preferably 20 to 50 nm, and more preferably 20 to 45 nm.

Examples of the ferromagnetic metal powder include yttrium-containing Fe, Fe—Co, Fe—Ni, and Co—Ni—Fe, and the yttrium content in the ferromagnetic metal powder is preferably 0.5 to 20 atom % as the yttrium atom/iron atom ratio Y/Fe, and more preferably 5 to 10 atom % It is preferable if the yttrium content is in such a range since the ferromagnetic metal powder has a high σs value, and good magnetic properties and electromagnetic conversion characteristics can be obtained. Furthermore, it is also possible for aluminum, silicon, sulfur, scandium, titanium, vanadium, chromium, manganese, copper, zinc, molybdenum, rhodium, palladium, tin, antimony, boron, barium, tantalum, tungsten, rhenium, gold, lead, phosphorus, lanthanum, cerium, praseodymium, neodymium, tellurium, bismuth, etc. to be present at 20 atom % or less relative to 100 atom % of iron. It is also possible for the ferromagnetic metal powder to contain a small amount of water, a hydroxide, or an oxide.

One example of a process for producing the ferromagnetic metal powder of the present invention, into which cobalt or yttrium has been introduced, is illustrated below. For example, an iron oxyhydroxide obtained by blowing an oxidizing gas into an aqueous suspension in which a ferrous salt and an alkali have been mixed can be used as a starting material. This iron oxyhydroxide is preferably of the α-FeOOH type. With regard to a production process therefor, there is a first production process in which a ferrous salt is neutralized with an alkali hydroxide to form an aqueous suspension of Fe(OH)₂, and an oxidizing gas is blown into this suspension to give acicular α-FeOOH. There is also a second production process in which a ferrous salt is neutralized with an alkali carbonate to form an aqueous suspension of FeCO₃, and an oxidizing gas is blown into this suspension to give spindle-shaped α-FeOOH. Such an iron oxyhydroxide is preferably obtained by reacting an aqueous solution of a ferrous salt with an aqueous solution of an alkali to give an aqueous solution containing ferrous hydroxide, and then oxidizing this with air, etc. In this case, the aqueous solution of the ferrous salt may contain an Ni salt, a salt of an alkaline earth element such as Ca, Ba, or Sr, a Cr salt, a Zn salt, etc., and by selecting these salts appropriately the particle shape (axial ratio), etc. can be adjusted.

As the ferrous salt, ferrous chloride, ferrous sulfate, etc. are preferable. As the alkali, sodium hydroxide, aqueous ammonia, ammonium carbonate, sodium carbonate, etc. are preferable. With regard to salts that can be present at the same time, chlorides such as nickel chloride, calcium chloride, barium chloride, strontium chloride, chromium chloride, and zinc chloride are preferable.

In a case where cobalt is subsequently introduced into the iron, before introducing yttrium, an aqueous solution of a cobalt compound such as cobalt sulfate or cobalt chloride is mixed and stirred with a slurry of the above-mentioned iron oxyhydroxide. After the slurry of iron oxyhydroxide containing cobalt is prepared, an aqueous solution containing a yttrium compound is added to this slurry, and they are stirred and mixed.

In the present invention, neodymium, samarium, praseodymium, lanthanum, gadolinium, etc. can be introduced into the ferromagnetic metal powder of the present invention as well as yttrium. They can be introduced using a chloride such as yttrium chloride, neodymium chloride, samarium chloride, praseodymium chloride, or lanthanum chloride or a nitrate salt such as neodymium nitrate or gadolinium nitrate, and they can be used in a combination of two or more types.

The coercive force (Hc) of the ferromagnetic metal powder is preferably 159.2 to 238.8 kA/m (2.000 to 3,000 Oe), and more preferably 167.2 to 230.8 kA/m (2,100 to 2,900 Oe). The saturation magnetic flux density is preferably 150 to 300 mT (1,500 to 3,000 G), and more preferably 160 to 290 mT (1,600 to 2,900 G). The saturation magnetization (σs) is preferably 100 to 170 A·m²/kg (100 to 170 emu/g), and more preferably 100 to 160 A·m²/kg (100 tp 160 emu/g).The SFD (switching field distribution) of the magnetic substance itself is preferably low, and 0.8 or less is preferred. When the SFD is 0.8 or less, the electromagnetic conversion characteristics become good, the output becomes high, the magnetization reversal becomes sharp with a small peak shift, and it is suitable for high-recording-density digital magnetic recording. In order to narrow the Hc distribution, there is a technique of improving the particle distribution of goethite, a technique of using monodispersed α-Fe₂O₃, and a technique of preventing sintering between particles, etc. in the ferromagnetic metal powder.

### (2) Tabular Magnetic Substance

The tabular magnetic substance that can be used in the present invention is preferably a hexagonal ferrite powder. Examples of the hexagonal ferrite powder include substitution products of barium ferrite, strontium ferrite, lead ferrite, and calcium ferrite, and Co substitution products. Specifically, magnetoplumbite type barium ferrite and strontium ferrite, magnetoplumbite type ferrite with a particle surface coated with a spinel, magnetoplumbite type barium ferrite and strontium ferrite partially containing a spinel phase, etc., can be cited. It may contain, in addition to the designated atoms, an atom such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, or Zr. In general, those to which Co—Zn, Co—Ti, Co—Ti—Zr, Co—Ti—Zn, Ni—Ti—Zn, Nb—Zn—Co, Sb—Zn—Co, Nb—Zn, etc. have been added can be used. Characteristic impurities may be included depending on the starting material and the production process.

The particle size is preferably 10 to 50 nm as a hexagonal plate size. When a magnetoresistive head is used for playback, the plate size is preferably equal to or less than 45 nm so as to reduce noise. It is preferable if the plate size is in such a range, since stable magnetization can be expected due to the absence of thermal fluctuations. And since noise is reduced it is suitable for high density magnetic recording.

The tabular ratio (plate size/plate thickness) is preferably 1 to 15, and more preferably 2 to 7. It is preferable if the tabular ratio is in such a range since adequate orientation can be obtained, and noise due to inter-particle stacking decreases. The specific surface area measured by the BET method (S_{BET}) of a powder having a particle size within this range is usually 10 to 200 m²/g. The specific surface area substantially coincides with the value obtained by calculation using the plate size and the plate thickness. The crystallite size is preferably 50 to 450 angstrom, and more preferably 100 to 350 angstrom. The plate size and the plate thickness distributions are preferably as narrow as possible. Although it is difficult, the distribution can be expressed using a numerical value by randomly measuring 500 particles on a TEM photograph of the particles. The distribution is not a regular distribution in many cases, but the standard deviation calculated with respect to the average size is preferably σ/average size=0.1 to 2.0. In order to narrow the particle size distribution, the reaction system used for forming the particles is made as homogeneous as possible, and the particles so formed are subjected to a distribution-improving treatment. For example, a method of selectively dissolving ultrafine particles in an acid solution is also known.

The coercive force (Hc) measured for the magnetic substance can be adjusted so as to be on the order of 39.8 to 398 kA/m (500 to 5,000 Oe). A higher Hc is advantageous for high-density recording, but it is restricted by the capacity of the recording head. It is preferably on the order of 63.7 to 318.4 kA/m (800 to 4,000 Oe), but is more preferably at least 119.4 kA/m (1,500 Oe) and at most 278.6 kA/m (3,500 Oe). When the saturation magnetization of the head exceeds 1.4 T, it is preferably 159.2 kA/m (2,000 Oe) or higher.

The Hc can be controlled by the particle size (plate size, plate thickness), the type and amount of element included, the element replacement sites, the conditions used for the particle formation reaction, etc. The saturation magnetization (as) is preferably 40 to 80 A·m²/kg (40 to 80 emu/g). A higher as is preferable, but there is a tendency for it to become lower when the particles become finer. In order to improve the as, making a composite of magnetoplumbite ferrite with spinel ferrite, selecting the types of element included and their amount, etc. are well known. It is also possible to use a W type hexagonal ferrite.

When dispersing the magnetic substance, the surface of the magnetic substance can be treated with a material that is compatible with a dispersing medium and the polymer. With regard to a surface-treatment agent, an inorganic or organic compound can be used. Representative examples include oxides and hydroxides of Si, Al, P, etc., and various types of silane coupling agents and various kinds of titanium coupling agents. The amount thereof is preferably 0.1% to 10% based on the magnetic substance. The pH of the magnetic substance is also important for dispersion. It is usually on the order of 4 to 12, and although the optimum value depends on the dispersing medium and the polymer, it is selected from on the order of 6 to 10 from the viewpoints of chemical stability and storage properties of the magnetic recording medium. The moisture contained in the magnetic substance also influences the dispersion. Although the optimum value depends on the dispersing medium and the polymer, it is usually selected from 0.01% to 2.0%.

With regard to a production method for the ferromagnetic hexagonal ferrite powder, there are:

glass crystallization method (1) in which barium oxide, iron oxide, a metal oxide that replaces iron, and boron oxide, etc. as glass forming materials are mixed so as to give a desired ferrite composition, then melted and rapidly cooled to give an amorphous substance, subsequently reheated, then washed and ground to give a barium ferrite crystal powder;

hydrothermal reaction method (2) in which a barium ferrite composition metal salt solution is neutralized with an alkali, and after a by-product is removed, it is heated in a liquid phase at 100° C. or higher, then washed, dried and ground to give a barium ferrite crystal powder; and

co-precipitation method (3) in which a barium ferrite composition metal salt solution is neutralized with an alkali, and after a by-product is removed, it is dried and treated at 1100° C. or less, and ground to give a barium ferrite crystal powder, etc., but a hexagonal ferrite used in the present invention may be produced by any method.

### (3) Spherical or Ellipsoidal Magnetic Substance

The spherical or ellipsoidal magnetic substance is preferably an iron nitride-based ferromagnetic powder containing Fe₁₆N₂ as a main phase. It may comprise, in addition to Fe and N atoms, an atom such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, or Zr. The content of N relative to Fe is preferably 1.0 to 20.0 atom %.

The iron nitride is preferably spherical or ellipsoidal, and the major axis length/minor axis length axial ratio of the spherical magnetic substance is preferably from not less than 1 to less than 2. And the major axis length/minor axis length axial ratio of the ellipsoidal magnetic substance is preferably from not less than 2 to less than 4. The BET specific surface area (SBET) is preferably 30 to 100 m²/g, and more preferably 50 to 70 m²/g. The crystallite size is preferably 12 to 25 nm, and more preferably 13 to 22 nm. The saturation magnetization σs is preferably 50 to 200 A·m²/kg (emu/g), and more preferably 70 to 150 A·m²/kg (emu/g).

### 2. Binder

Examples of the binder used in the magnetic layer include a polyurethane resin, a polyester resin, a polyamide resin, a vinyl chloride resin, an acrylic resin obtained by copolymerization of styrene, acrylonitrile, methyl methacrylate, etc., a cellulose resin such as nitrocellulose, an epoxy resin, a phenoxy resin, and a polyvinyl alkyral resin such as polyvinyl acetal or polyvinyl butyral, and they can be used singly or in a combination of two or more types. Among these, the polyurethane resin, the acrylic resin, the cellulose resin, and the vinyl chloride resin are preferable.

In order to improve the dispersibility of the ferromagnetic powder and the non-magnetic powder, the binder preferably has a functional group (polar group) that is adsorbed on the surface of the powders. Preferred examples of the functional group include —SO₃M, —SO₄M, —PO(OM)₂, —OPO(OM)₂, —COOM, >NSO₃M, >NRSO₃M, —NR¹R², and —N⁺R¹R²R³X⁻. M denotes a hydrogen atom or an alkali metal such as Na or K, R denotes an alkylene group, R¹, R², and R³ denote alkyl groups, hydroxyalkyl groups, or hydrogen atoms, and X denotes a halogen such as Cl or Br. The amount of functional group in the binder is preferably 10 to 200 μeq/g, and more preferably 30 to 120 μeq/g. It is preferable if it is in this range since good dispersibility can be achieved.

The binder preferably includes, in addition to the adsorbing functional group, a functional group having an active hydrogen, such as an —OH group, in order to improve the coating strength by reacting with an isocyanate curing agent so as to form a crosslinked structure. A preferred amount is 0.1 to 2 meq/g.

The molecular weight of the binder is preferably 10,000 to 200,000 as a weight-average molecular weight, and more preferably 20,000 to 100,000. It is preferable if the weight-average molecular weight is in this range since the coating strength is sufficient, the durability is good, and the dispersibility improves.

The polyurethane resin, which is a preferred binder, is described in detail in, for example, ‘Poriuretan Jushi Handobukku’ (Polyurethane Resin Handbook) (Ed., K. Iwata, 1986, The Nikkan Kogyo Shimbun, Ltd.), and it may normally be obtained by addition-polymerization of a long chain diol, a short chain diol (also known as a chain extending agent), and a diisocyanate compound. As the long chain diol, a polyester diol, a polyether diol, a polyetherester diol, a polycarbonate diol, a polyolefin diol, etc, having a molecular weight of 500 to 5,000 may be used. Depending on the type of this long chain polyol, the polyurethane is called a polyester urethane, a polyether urethane, a polyetherester urethane, a polycarbonate urethane, etc.

The polyester diol may be obtained by a condensation-polymerization between a glycol and a dibasic aliphatic acid such as adipic acid, sebacic acid, or azelaic acid, or a dibasic aromatic acid such as isophthalic acid, orthophthalic acid, terephthalic acid, or naphthalenedicarboxylic acid. Examples of the glycol component include ethylene glycol, 1,2-propylene glycol, 1,3-propanediol, 1,4-butanediol, 1,5-pentanediol, 3-methyl-1,5-pentanediol, 1,6-hexanediol, 2,2-dimethyl-1,3-propanediol, 1,8-octanediol, 1,9-nonanediol, cyclohexanediol, cyclohexanedimethanol, and hydrogenated bisphenol A. As the polyester diol, in addition to the above, a polycaprolactonediol or a polyvalerolactonediol obtained by ring-opening polymerization of a lactone such as ε-caprolactone or γ-valerolactone can be used.

From the viewpoint of resistance to hydrolysis, the polyester diol is preferably one having a branched side chain or one obtained from an aromatic or alicyclic starting material. Examples of the polyether diol include polyethylene glycol, polypropylene glycol, polytetramethylene glycol, aromatic glycols such as bisphenol A, bisphenol S, bisphenol P, and hydrogenated bisphenol A, and addition-polymerization products from an alicyclic diol and an alkylene oxide such as ethylene oxide or propylene oxide. These long chain diols can be used as a mixture of a plurality of types thereof.

The short chain diol can be chosen from the compound group that is cited as the glycol component of the above-mentioned polyester diol. Furthermore, a small amount of a tri- or higher-hydric alcohol such as, for example, trimethylolethane, trimethylolpropane, or pentaerythritol can be added, and this gives a polyurethane resin having a branched structure, thus reducing the solution viscosity and increasing the number of OH end groups of the polyurethane so as to improve the curability with the isocyanate curing agent.

Examples of the diisocyanate compound include aromatic diisocyanates such as MDI (diphenylmethane diisocyanate), 2,4-TDI (tolylene diisocyanate), 2,6-TDI, 1,5-NDI (naphthalene diisocyanate), TODI (tolidine diisocyanate), p-phenylene diisocyanate, and XDI (xylylene diisocyanate), and aliphatic and alicyclic diisocyanates such as trans-cyclohexane-1,4-diisocyanate, HDI (hexamethylene diisocyanate), IPDI (isophorone diisocyanate), H₆XDI (hydrogenated xylylene diisocyanate), and H₁₂MDI (hydrogenated diphenylmethane diisocyanate).

The long chain diol/short chain diol/ciisocyanate ratio in the polyurethane resin is preferably (80 to 15 wt %)/(5 to 40 wt %)/(15 to 50 wt %).

The concentration of urethane groups in the polyurethane resin is preferably 1 to 5 meq/g, and more preferably 1.5 to 4.5 meq/g. It is preferable if the concentration of urethane groups is in the above range since the mechanical strength is high, the solution viscosity is low and the good dispersibility can be achieved.

The glass transition temperature of the polyurethane resin is preferably 0° C. to 200° C., and more preferably 40° C. to 160° C. In this range, sufficient durability and moldability are obtained, and excellent electromagnetic conversion characteristics are obtained.

With regard to a method for introducing the adsorbing functional group (polar group) into the polyurethane resin, there are, for example, a method in which the functional group is used in a part of the long chain diol monomer, a method in which it is used in a part of the short chain diol, and a method in which, after the polyurethane is formed by polymerization, the polar group is introduced by a polymer reaction.

As the vinyl chloride resin, a copolymer of a vinyl chloride monomer and various types of monomer may be used.

Examples of the comonomer include fatty acid vinyl esters such as vinyl acetate and vinyl propionate, acrylates and methacrylates such as methyl (meth)acrylate, ethyl (meth)acrylate, isopropyl (meth)acrylate, butyl (meth)acrylate, and benzyl (meth)acrylate, alkyl allyl ethers such as allyl methyl ether, allyl ethyl ether, allyl propyl ether, and allyl butyl ether, and others such as styrene, ac-methylstyrene, vinylidene chloride, acrylonitrile, ethylene, butadiene, and acrylamide; examples of a comonomer having a functional group include vinyl alcohol, 2-hydroxyethyl (meth)acrylate, polyethylene glycol (meth)acrylate, 2-hydroxypropyl (meth)acrylate, 3-hydroxypropyl (meth)acrylate, polypropylene glycol (meth)acrylate, 2-hydroxyethyl allyl ether, 2-hydroxypropyl allyl ether, 3-hydroxypropyl allyl ether, p-vinylphenol, maleic acid, maleic anhydride, acrylic acid, methacrylic acid, glycidyl (meth)acrylate, allyl glycidyl ether, phosphoethyl (meth)acrylate, sulfoethyl (meth)acrylate, p-styrenesulfonic acid, and Na salts and K salts thereof.

The proportion of the vinyl chloride monomer in the vinyl chloride resin is preferably 60 to 95 wt %. It is preferable if it is in this range since the mechanical strength improves, the solvent solubility is high, and good dispersibility can be obtained due to desirable solution viscosity.

A preferred amount of a functional group for improving the curability of the adsorbing functional group (polar group) with a polyisocyanate curing agent is as described above. With regard to a method for introducing these functional groups, a monomer containing the above-mentioned functional group may be copolymerized, or after the vinyl chloride resin is formed by copolymerization, the functional group may be introduced by a polymer reaction.

A preferred degree of polymerization is 200 to 600, and more preferably 240 to 450. It is preferable if the degree of polymerization is in this range since the mechanical strength is high and good dispersibility can be obtained due to desirable solution viscosity.

In order to increase the mechanical strength and heat resistance of a coating by crosslinking and curing the binder used in the present invention, it is possible to use a curing agent. A preferred curing agent is a polyisocyanate compound. The polyisocyanate compound is preferably a tri- or higher-functional polyisocyanate.

Specific examples thereof include adduct type polyisocyanate compounds such as a compound in which 3 moles of TDI (tolylene diisocyanate) are added to 1 mole of trimethylolpropane (TMP), a compound in which 3 moles of HDI (hexamethylene diisocyanate) are added to 1 mole of TMP, a compound in which 3 moles of IPDI (isophorone diisocyanate) are added to 1 mole of TMP, and a compound in which 3 moles of XDI (xylylene diisocyanate) are added to 1 mole of TMP, a condensed isocyanurate type trimer of TDI, a condensed isocyanurate type pentamer of TDI, a condensed isocyanurate heptamer of TDI, mixtures thereof, an isocyanurate type condensation product of HDI, an isocyanurate type condensation product of IPDI, and crude MDI. Among these, the compound in which 3 moles of TDI are added to 1 mole of TMP, and the isocyanurate type trimer of TDI are preferable.

Other than the isocyanate curing agents, a radiation curing agent that cures when exposed to an electron beam, ultraviolet rays, etc. may be used. In this case, it is possible to use a curing agent having, as radiation curing functional groups, two or more, and preferably three or more, acryloyi or methacryloyl groups per molecule. Examples thereof include TMP (trimethylolpropane) triacrylate, pentaerythritol tetraacrylate, and a urethane acrylate oligomer. In this case, it is preferable to introduce a (meth)acryloyl group not only into the curing agent but also into the binder. In the case of curing with ultraviolet rays, a photosensitizer is additionally used.

It is preferable to add 0 to 80 parts by weight of the curing agent relative to 100 parts by weight of the binder. It is preferable if the amount is in this range since the dispersibility is good.

The amount of binder added to the magnetic layer is preferably 5 to 30 parts by weight relative to 100 parts by weight of the ferromagnetic powder, and more preferably 10 to 20 parts by weight.

### 3. Additives

Additives may be added as necessary to the magnetic layer of the present invention. Examples of the additives include an abrasive, a lubricant, a dispersant/dispersion adjuvant, a fungicide, an antistatic agent, an antioxidant, a solvent, and carbon black.

Examples of these additives include molybdenum disulfide, tungsten disulfide, graphite, boron nitride, graphite fluoride, a silicone oil, a polar group-containing silicone, a fatty acid-modified silicone, a fluorine-containing silicone, a fluorine-containing alcohol, a fluorine-containing ester, a polyolefin, a polyglycol, a polyphenyl ether; aromatic ring-containing organic phosphonic acids such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, tolylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid, and alkali metal salts thereof; alkylphosphonic acids such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, and isoeicosylphosphonic acid, and alkali metal salts thereof; aromatic phosphates such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, tolyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate, and alkali metal salts thereof; alkyl phosphates such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate, and alkali metal salts thereof; and alkyl sulfonates and alkali metal salts thereof; fluorine-containing alkyl sulfates and alkali metal salts thereof; monobasic fatty acids that have 10 to 24 carbons, may contain an unsaturated bond, and may be branched, such as lauric acid, myristic acid, palmitic acid, stearic acid, behenic acid, oleic acid, linoleic acid, linolenic acid, elaidic acid, and erucic acid, and metal salts thereof; mono-fatty acid esters, di-fatty acid esters, and poly-fatty acid esters such as butyl stearate, octyl stearate, amyl stearate, isooctyl stearate, octyl myristate, butyl laurate, butoxyethyl stearate, anhydrosorbitan monostearate, anhydrosorbitan distearate, and anhydrosorbitan tristearate that are formed from a monobasic fatty acid that has 10 to 24 carbons, may contain an unsaturated bond, and may be branched, and any one of a mono- to hexa-hydric alcohol that has 2 to 22 carbons, may contain an unsaturated bond, and may be branched, an alkoxy alcohol that has 12 to 22 carbons, may have an unsaturated bond, and may be branched, and a mono alkyl ether of an alkylene oxide polymer; fatty acid amides having 2 to 22 carbons; aliphatic amines having 8 to 22 carbons; etc. Other than the above-mentioned hydrocarbon groups, those having an alkyl, aryl, or aralkyl group that is substituted with a group other than a hydrocarbon group, such as a nitro group, F, Cl, Br, or a halogen-containing hydrocarbon such as CF₃, CCI₃, or CBr₃ can also be used.

Furthermore, there are a nonionic surfactant such as an alkylene oxide type, a glycerol type, a glycidol type, or an alkylphenol-ethylene oxide adduct; a cationic surfactant such as a cyclic amine, an ester amide, a quaternary ammonium salt, a hydantoin derivative, a heterocyclic compound, a phosphonium salt, or a sulfonium salt; an anionic surfactant containing an acidic group such as a carboxylic acid, a sulfonic acid or a sulfate ester group; and an amphoteric surfactant such as an amino acid, an aminosulfonic acid, a sulfate ester or a phosphate ester of an amino alcohol, or an alkylbetaine. Details of these surfactants are described in ‘Kaimenkasseizai Binran’ (Surfactant Handbook) (published by Sangyo Tosho Publishing).

These dispersants, lubricants, etc. need not always be pure and may contain, in addition to the main component, an impurity such as an isomer, an unreacted material, a by-product, a decomposition product, or an oxide. However, the impurity content is preferably 30 wt % or less, and more preferably 10 wt % or less.

Specific examples of these additives include NAA-102, hardened castor oil fatty acid, NAA-42, Cation SA, Nymeen L-201, Nonion E-208, Anon BF, and Anon LG, (produced by Nippon Oil & Fats Co., Ltd.); FAL-205, and FAL-123 (produced by Takemoto Oil & Fat Co., Ltd); Enujelv OL (produced by New Japan Chemical Co., Ltd.); TA-3 (produced by Shin-Etsu Chemical Industry Co., Ltd.); Armide P (produced by Lion Armour); Duomin TDO (produced by Lion Corporation); BA-41G (produced by The Nisshin Oilli 0 Group, Ltd.); and Profan 201 2E, Newpol PE 61, and lonet MS-400 (produced by Sanyo Chemical Industries, Ltd.).

### 4. Organic Solvent

In the present invention, an organic solvent used for the magnetic layer can be a known organic solvent. As the organic solvent, a ketone such as acetone, methyl ethyl ketone, methyl isobutyl ketone, diisobutyl ketone, cyclohexanone, or isophorone, an alcohol such as methanol, ethanol, propanol, butanol, isobutyl alcohol, isopropyl alcohol, or methylcyclohexanol, an ester such as methyl acetate, butyl acetate, isobutyl acetate, isopropyl acetate, ethyl lactate, or glycol acetate, a glycol ether such as glycol dimethyl ether, glycol monoethyl ether, or dioxane, an aromatic hydrocarbon such as benzene, toluene, xylene, or cresol, a chlorohydrocarbon such as methylene chloride, ethylene chloride, carbon tetrachloride, chloroform, ethylene chlorohydrin, chlorobenzene, or dichlorobenzene, N,N-dimethylformamide, hexane, tetrahydrofuran, etc. can be used at any ratio.

These organic solvents do not always need to be 100% pure, and may contain an impurity such as an isomer, an unreacted compound, a by-product, a decomposition product, an oxide, or moisture in addition to the main component. The content of these impurities is preferably 30% or less, and more preferably 10% or less. The organic solvent used in the present invention is preferably the same type for both the magnetic layer and a non-magnetic layer. However, the amount added may be varied. The coating stability is improved by using a high surface tension solvent (cyclohexanone, dioxane, etc.) for the non-magnetic layer; more specifically, it is important that the arithmetic mean value of the surface tension of the magnetic layer (upper layer) solvent composition is not less than that for the surface tension of the non-magnetic layer solvent composition. In order to improve the dispersibility, it is preferable for the polarity to be somewhat strong, and the solvent composition preferably contains 50% or more of a solvent having a permittivity of 15 or higher. The solubility parameter is preferably 8 to 11.

The type and the amount of the dispersant, lubricant, and surfactant used in the magnetic layer of the present invention can be changed as necessary in the magnetic layer and a non-magnetic layer, which will be described later. For example, although not limited to only the examples illustrated here, the dispersant has the property of adsorbing or bonding via its polar group, and it is surmised that the dispersant adsorbs or bonds, via the polar group, to mainly the surface of the ferromagnetic powder in the magnetic layer and mainly the surface of the non-magnetic powder in the non-magnetic layer, which will be described later, and once adsorbed it is hard to desorb an organophosphorus compound from the surface of a metal, a metal compound, etc. Therefore, since in the present invention the surface of the ferromagnetic powder or the surface of a non-magnetic powder, which will be described later, are in a state in which they are covered with an alkyl group, an aromatic group, etc., the affinity of the ferromagnetic powder or the non-magnetic powder toward the binder resin component increases and, furthermore, the dispersion stability of the ferromagnetic powder or the non-magnetic powder is also improved. With regard to the lubricant, since it is present in a free state, its exudation to the surface is controlled by using fatty acids having different melting points for the non-magnetic layer and the magnetic layer or by using esters having different boiling points or polarity. The coating stability can be improved by regulating the amount of surfactant added, and the lubrication effect can be improved by increasing the amount of lubricant added to the non-magnetic layer. Furthermore, all or a part of the additives used in the present invention may be added to a magnetic coating solution or a non-magnetic coating solution at any stage of its preparation. For example, the additives may be blended with a ferromagnetic powder prior to a kneading step, they may be added in a step of kneading a ferromagnetic powder, a binder, and a solvent, they may be added in a dispersing step, they may be added after dispersion, or they may be added immediately prior to coating.

### 5. Carbon Black

The carbon black may be used singly or in a combination of different types thereof. When the carbon black is used, it is preferably used in an amount of 0.1 to 30 wt % based on the weight of the ferromagnetic powder. The carbon black has the functions of preventing static charging of the magnetic layer, reducing the coefficient of friction, imparting light-shielding properties, and improving the film strength. Such functions vary depending upon the type of carbon black. Accordingly, it is of course possible in the present invention to appropriately choose the type, the amount and the combination of carbon black for the magnetic layer according to the intended purpose on the basis of the above mentioned various properties such as the particle size, the oil absorption, the electrical conductivity, and the pH value, and it is better if they are optimized for the respective layers.

The type of carbon black that can be used includes furnace black for rubber, thermal black for rubber, carbon black for coloring, acetylene black, etc.

The carbon black that can be used in the present invention can be selected by referring to, for example, the ‘Kabon Burakku Binran’ (Carbon Black Handbook) (edited by the Carbon Black Association of Japan).

The specific surface area of the carbon black is preferably 100 to 500 m²/g, and more preferably 150 to 400 m²/g. The dibutylphthalate (DBP) oil absorption thereof is preferably 20 to 400 mL/100 g, and more preferably 30 to 200 mL/100 g. The average particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black used in the present invention include BLACKPEARLS 2000, 1300, 1000, 900, 800, 880 and 700, and VULCAN XC-72 (manufactured by Cabot Corporation), #3050B, #3150B; #3250B, #3750B, #3950B, #950, #650B, #970B, #850B, MA-600, MA-230, #4000, and #4010 (manufactured by Mitsubishi Chemical Corporation), CONDUCTEX SC, RAVEN 8800, 8000, 7000, 5750, 5250, 3500, 2100, 2000, 1800, 1500, 1255, and 1250 (manufactured by Columbian Carbon Co.), Ketjen Black EC (manufactured by Akzo), Ketjen Black EC (manufactured by Ketjen Black International Co.).

### III. Non-Magnetic Layer

The magnetic recording medium of the present invention can include a non-magnetic layer on a radiation-cured layer (H) which is provided on a non-magnetic support, the non-magnetic layer containing a binder and a non-magnetic powder. The non-magnetic powder that can be used in the non-magnetic layer may be an inorganic substance or an organic substance. In order to coordinate a modulus of elasticity and a hardness of the non-magnetic layer, the layer may further include carbon black as necessary together with the non-magnetic powder. The present invention can provide a magnetic recording medium that has high conductivity by comprising a conductive polymer (E) in the radiation-cured layer (H). Therefore, design variations can be possible by reducing the amount of a conductive particulate substance such as carbon black, which is conventionally added to the non-conductive layer, or reducing the thickness of the non-magnetic layer.

### 1. Non-Magnetic Powder

Details of the non-magnetic layer are now explained. The magnetic recording medium of the present invention may include a non-magnetic layer (a lower layer) including a non-magnetic powder and a binder above a non-magnetic support provided with a radiation-cured layer. The non-magnetic layer may employ a magnetic powder as long as the lower layer is substantially non-magnetic, but preferably employs a non-magnetic powder. The non-magnetic powder that can be used in the non-magnetic layer may be an inorganic substance or an organic substance. It is also possible to use carbon black, etc. Examples of the inorganic substance include a metal, a metal oxide, a metal carbonate, a metal sulfate, a metal nitride, a metal carbide, and a metal sulfide. Specific examples thereof include a titanium oxide such as titanium dioxide, cerium oxide, tin oxide, tungsten oxide, ZnO, ZrO₂, SiO₂, Cr₂O₃, α-alumina having an α-component proportion of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide, and they can be used singly or in a combination of two or more types. ap-ron oxide or a titanium oxide is preferable.

The form of the non-magnetic powder may be any one of acicular, spherical, polyhedral, and tabular. The crystallite size of the non-magnetic powder is preferably 4 nm to 1 μm, and more preferably 40 to 100 nm. When the crystallite size is in the range of 4 nm to 1 μm, there are no problems with dispersion and a suitable surface roughness is obtained. The average particle size of these non-magnetic powders is preferably 5 nm to 2 μm, but it is possible to combine non-magnetic powders having different average particle sizes as necessary, or widen the particle size distribution of a single non-magnetic powder, thus producing the same effect. The average particle size of the non-magnetic powder is particularly preferably 10 to 200 nm. It is preferable if it is in the range of 5 nm to 2 μm, since good dispersibility and a suitable surface roughness can be obtained.

The specific surface area of the non-magnetic powder is preferably 1 to 100 m²/g, more preferably 5 to 70 m²/g, and yet more preferably 10 to 65 m²/g. It is preferable if the specific surface area is in the range of 1 to 100 m²/g, since a suitable surface roughness can be obtained, and dispersion can be carried out using a desired amount of binder.

The oil absorption obtained using dibutyl phthalate (DBP) is preferably 5 to 100 mL/100 g, more preferably 10 to 80 mL/100 g, and yet more preferably 20 to 60 mL/100 g.

The specific gravity is preferably 1 to 12, and more preferably 3 to 6. The tap density is preferably 0.05 to 2 g/mL, and more preferably 0.2 to 1.5 g/mL. When the tap density is in the range of 0.05 to 2 g/mL, there is little scattering of particles, the operation is easy, and there tends to be little sticking to equipment.

The pH of the non-magnetic powder is preferably 2 to 11, and particularly preferably 6 to 9. When the pH is in the range of 2 to 11, the coefficient of friction does not increase as a result of high temperature and high humidity or release of a fatty acid. The water content of the non-magnetic powder is preferably 0.1 to 5 wt %, more preferably 0.2 to 3 wt %, and yet more preferably 0.3 to 1.5 wt %. It is preferable if the water content is in the range of 0.1 to 5 wt %, since dispersion is good, and the viscosity of a dispersed coating solution becomes stable. The ignition loss is preferably 20 wt % or less, and a small ignition loss is preferable.

When the non-magnetic powder is an inorganic powder, the Mohs hardness thereof is preferably in the range of 4 to 10. When the Mohs hardness is in the range of 4 to 10, it is possible to guarantee the durability. The amount of stearic acid absorbed by the non-magnetic powder is 1 to 20 μmol/m², and preferably 2 to 15 μmol/m². The heat of wetting of the non-magnetic powder in water at 25° C. is preferably in the range of 20 to 60 μJ/cm² (200 to 600 erg/cm²). It is possible to use a solvent that gives a heat of wetting in this range. The number of water molecules on the surface at 100° C. to 400° C. is suitably 1 to 10/100 Å. The pH at the isoelectric point in water is preferably between 3 and 9.

The surface of the non-magnetic powder is preferably subjected to a surface treatment with Al₂O₃, SiO₂, TiO₂, ZrO₂, SnO₂, Sb₂O₃, or ZnO. In terms of dispersibility in particular, Al₂O₃, SiO₂, TiO₂, and ZrO₂ are preferable, and Al₂O₃, SiO₂, and ZrO₂ are more preferable. They may be used in combination or singly. Depending on the intended purpose, a surface-treated layer may be obtained by co-precipitation, or a method can be employed in which the surface is firstly treated with alumina and the surface thereof is then treated with silica, or vice versa. The surface-treated layer may be formed as a porous layer depending on the intended purpose, but it is generally preferable for it to be uniform and dense.

Specific examples of the non-magnetic powder used in the non-magnetic layer in the present invention include Nanotite (manufactured by Showa Denko K. K.), HIT-100 and ZA-G1 (manufactured by Sumitomo Chemical Co., Ltd.), DPN-250, DPN-250BX, DPN-245, DPN-270BX, DPB-550BX, and DPN-550RX (manufactured by Toda Kogyo Corp.), titanium oxide TTO-51B, TTO-55A, TTO-55B, TTO-55C, TTO-55S, TTO-55D, and SN-100, MJ-7, and α-iron oxide E270, E271, and E300 (manufactured by Ishihara Sangyo Kaisha Ltd.), titanium oxide STT-4D, STT-30D, STT-30, and STT-65C (manufactured by Titan Kogyo Kabushiki Kaisha), MT-100S, MT-100T, MT-150W, MT-500B, MT-600B, MT-100F, and MT-500HD (manufactured by Tayca Corporation), FINEX-25, BF-1, BF-10, BF-20, and ST-M (manufactured by Sakai Chemical Industry Co., Ltd.), DEFIC-Y and DEFIC-R (manufactured by Dowa Mining Co., Ltd.), AS2BM and TiO₂P25 (manufactured by Nippon Aerosil Co., Ltd.), 100A, and 500A (manufactured by Ube Industries, Ltd.), Y-LOP (manufactured by Titan Kogyo Kabushiki Kaisha), and calcined products thereof. Particularly preferred non-magnetic powders are titanium dioxide and α-iron oxide.

By mixing carbon black with the non-magnetic powder, the surface electrical resistance of the non-magnetic layer can be reduced, the light transmittance can be decreased, and a desired μVickers hardness can be obtained. The μVickers hardness of the non-magnetic layer is preferably 25 to 60 kg/mm², and is more preferably 30 to 50 kg/mm² in order to adjust the head contact. The μVickers hardness can be measured using a thin film hardness meter (HMA-400 manufactured by NEC Corporation) with, as an indentor tip, a triangular pyramidal diamond needle having a tip angle of 800 and a tip radius of 0.1 μm. The light transmittance is generally standardized such that the absorption of infrared rays having a wavelength of on the order of 900 nm is 3% or less and, in the case of, for example, VHS magnetic tapes, 0.8% or less. Because of this, furnace black for rubber, thermal black for rubber, carbon black for coloring, acetylene black, etc. can be used.

The specific surface area of the carbon black used in the non-magnetic layer in the present invention is preferably 100 to 500 m²/g, and more preferably 150 to 400 m²/g, and the DBP oil absorption thereof is preferably 20 to 400 mL/100 g, and more preferably 30 to 200 mL/100 g. The particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black that can be used in the non-magnetic layer in the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, and MA-600 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured by Columbian Carbon Co.), Ketjen Black EC (manufactured by Akzo), and Ketjen Black EC (manufactured by Ketjen Black International Corporation).

The carbon black may be surface treated using a dispersant or grafted with a resin, or part of the surface thereof may be converted into graphite. Prior to adding carbon black to a coating solution, the carbon black may be predispersed with a binder.

The carbon black is preferably added in a range not exceeding 30 parts by weight relative to 100 parts by weight of the total amount of magnetic powder and non-magnetic powder, more preferably in a range not exceeding 15 parts by weight, and yet more preferably in a range not exceeding 10 parts by weight. Moreover, it is preferably used in a range not exceeding 20 parts by weight relative to 100 parts by weight of the solids content of the non-magnetic layer, more preferably in a range not exceeding 10 parts by weight, and yet more preferably in a range not exceeding 5 parts by weight.

These types of carbon black may be used singly or in combination. The carbon black that can be used in the non-magnetic layer of the present invention can be selected by referring to, for example, the ‘Kabon Burakku Binran (Carbon Black Handbook) (edited by the Carbon Black Association of Japan).

It is also possible to add an organic powder to the non-magnetic layer, depending on the intended purpose. Examples of such an organic powder include an acrylic styrene resin powder, a benzoguanamine resin powder, a melamine resin powder, and a phthalocyanine pigment, but a polyolefin resin powder, a polyester resin powder, a polyamide resin powder, a polyimide resin powder, and a polyfluoroethylene resin can also be used. Production methods such as those described in JP-A-62-18564 and JP-A-60-255827 may be used.

### IV. Non-Magnetic Support

With regard to the non-magnetic support that can be used in the present invention, known biaxially stretched films such as polyethylene terephthalate, polyethylene naphthalate, polyamide, polyamideimide, and aromatic polyamide can be used. Among these, polyethylene terephthalate, polyethylene naphthalate, and polyamide are preferred.

These supports may be subjected in advance to a corona discharge treatment, a plasma treatment, a treatment for enhancing adhesion, a thermal treatment, etc. The non-magnetic support that can be used in the present invention preferably has a surface roughness such that its center plane average surface roughness Ra is in the range of 3 to 10 nm for a cutoff value of 0.25 mm.

### V. Backcoat Layer

In general, there is a strong requirement for magnetic tapes for recording computer data to have better repetitive transport properties than video tapes and audio tapes. In order to maintain such high storage stability, a backcoat layer can be provided on the surface of the non-magnetic support opposite to the surface where the non-magnetic layer and the magnetic layer are provided. As a coating solution for the backcoat layer, a binder and a particulate component such as an abrasive or an antistatic agent are dispersed in an organic solvent. As a granular component, various types of inorganic pigment or carbon black may be used. As the binder, a resin such as nitrocellulose, a phenoxy resin, a vinyl chloride resin, or a polyurethane can be used singly or in combination.

### VI. Layer Structure

The thickness of the non-magnetic support is preferably 3 to 80 μm. Moreover, the thickness of the backcoat layer provided on the surface of the non-magnetic support opposite to the surface where the non-magnetic layer and the magnetic layer are provided is preferably 0.1 to 1.0 μm, and more preferably 0.2 to 0.8 μm.

The thickness of the magnetic layer is optimized according to the saturation magnetization and the head gap of the magnetic head and the bandwidth of the recording signal, but it is preferably 0.01 to 0.15 μm, and more preferably 0.02 to 0.10 μm. The percentage variation in thickness of the magnetic layer is preferably ±50% or less, and more preferably ±40% or less. The magnetic layer can be at least one layer, but it is also possible to provide two or more separate layers having different magnetic properties, and a known configuration for a multilayer magnetic layer can be employed.

In the present invention, the thickness of the non-magnetic layer is preferably 2.0 μm or less, more preferably 1.0 μm or less, and yet more preferably 0 to 1.0 μm.

The non-magnetic layer of the magnetic recording medium of the present invention exhibits its effect if it is substantially non-magnetic, but even if it contains a small amount of a magnetic substance as an impurity or intentionally, if the effects of the present invention are exhibited the constitution can be considered to be substantially the same as that of the magnetic recording medium of the present invention. ‘Substantially the same’ referred to here means that the non-magnetic layer has a residual magnetic flux density of 10 mT (100 G) or less or a coercive force of 7.96 kA/m (100 Oe) or less, and preferably has no residual magnetic flux density and no coercive force.

### VII. Production Process

A process for preparing the radiation-cured layer (H) comprises, for example, a step of coating a non-magnetic support with a coating solution formed by dissolving or dispersing the conductive polymer (E), including dopant, and the radiation curing monomer (C) in a solvent such as an organic solvent or water, drying, and exposing to radiation, thus curing the radiation-cured layer (H).

A process for producing a non magnetic layer coating solutin or a magnetic layer coating solution for the magnetic recording medium used in the present invention comprises at least a kneading step, a dispersing step and, optionally, a blending step that is carried out prior to and/or subsequent to the above-mentioned steps. Each of these steps may be composed of two or more separate stages.

All materials, including the ferromagnetic hexagonal ferrite powder, the ferromagnetic metal powder, the non-magnetic powder, the binder, the carbon black, the abrasive, the antistatic agent, the lubricant, and the solvent used in the present invention may be added in any step from the beginning or during the course of the step. The addition of each material may be divided across two or more steps. For example, a polyurethane can be divided and added in a kneading step, a dispersing step, and a blending step for adjusting the viscosity after dispersion.

To attain the object of the present invention, a conventionally known production technique may be employed as a part of the steps. In the kneading step, it is preferable to use a powerful kneading machine such as an open kneader, a continuous kneader, a pressure kneader, or an extruder. When a kneader is used, all or a part of the binder (preferably 30 wt % or above of the entire binder) and the magnetic powder or the non-magnetic powder are kneaded at 15 to 500 parts by weight relative to 100 parts by weight of the ferromagnetic powder. Details of these kneading treatments are described in JP-A-1-106338 and JP-A-1-79274. For the dispersion of the magnetic layer solution and a non-magnetic layer solution, glass beads may be used. As such glass beads, a dispersing medium having a high specific gravity such as zirconia beads, titania beads, or steel beads is suitably used. An optimal particle size and packing density of these dispersing media is used. A known disperser can be used.

The process for producing the magnetic recording medium of the present invention includes, for example, coating the surface of a moving non-magnetic support with a magnetic layer coating solution so as to give a predetermined coating thickness. A plurality of magnetic layer coating solutions can be applied successively or simultaneously in multilayer coating, and a lower non-magnetic layer coating solution and an upper magnetic layer coating solution can also be applied successively or simultaneously in multilayer coating. As coating equipment for applying the above-mentioned magnetic layer coating solution or the lower non-magnetic layer coating solution, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, etc. can be used. With regard to these, for example, ‘Saishin Kotingu Gijutsu’ (Latest Coating Technology) (May 31, 1983) published by Sogo Gijutsu Center can be referred to.

In the case of a magnetic tape, the coated layer of the magnetic layer coating solution is subjected to a magnetic field alignment treatment in which the ferromagnetic powder contained in the coated layer of the magnetic layer coating solution is aligned in the longitudinal direction using a cobalt magnet or a solenoid. In the case of a disk, although sufficient isotropic alignment can sometimes be obtained without using an alignment device, it is preferable to employ a known random alignment device such as, for example, arranging obliquely alternating cobalt magnets or applying an alternating magnetic field with a solenoid. The isotropic alignment referred to here means that, in the case of a fine ferromagnetic metal powder, in general, in-plane two-dimensional random is preferable, but it can be three-dimensional random by introducing a vertical component. In the case of a hexagonal ferrite, in general, it tends to be in-plane and vertical three-dimensional random, but in-plane two-dimensional random is also possible. By using a known method such as magnets having different poles facing each other so as to make vertical alignment, circumferentially isotropic magnetic properties can be introduced. In particular, when carrying out high density recording, vertical alignment is preferable. Furthermore, circumferential alignment may be employed using spin coating.

It is preferable for the drying position for the coating to be controlled by controlling the drying temperature and blowing rate and the coating speed; it is preferable for the coating speed to be 20 to 1,000 m/min and the temperature of drying air to be 60° C. or higher, and an appropriate level of pre-drying may be carried out prior to entering a magnet zone.

After drying is carried out, the coated layer is subjected to a surface smoothing treatment. The surface smoothing treatment employs, for example, super calender rolls, etc. By carrying out the surface smoothing treatment, cavities formed by removal of the solvent during drying are eliminated, thereby increasing the packing ratio of the ferromagnetic powder in the magnetic layer, and a magnetic recording medium having high electromagnetic conversion characteristics can thus be obtained.

With regard to calendering rolls, rolls of a heat-resistant plastic such as epoxy, polyimide, polyamide, or polyamideimide are used. It is also possible to carry out a treatment with metal rolls. The magnetic recording medium of the present invention preferably has a surface, which is extremely smooth. As a method therefor, a magnetic layer formed by selecting a specific ferromagnetic powder and binder as described above is subjected to the above-mentioned calendering treatment. With regard to calendering conditions, the calender roll temperature is preferably in the range of 60° C. to 100° C., more preferably in the range of 70° C. to 100° C., and particularly preferably in the range of 80° C. to 100° C., and the pressure is preferably in the range of 100 to 500 kg/cm, more preferably in the range of 200 to 450 kg/cm, and particularly preferably in the range of 300 to 400 kg/cm.

As thermal shrinkage reducing means, there is a method in which a web is thermally treated while handling it with low tension, and a method (thermal treatment) involving thermal treatment of a tape when it is in a layered configuration such as in bulk or installed in a cassette, and either can be used. In the former method, the effect of the imprint of projections of the surface of the backcoat layer is small, but the thermal shrinkage cannot be greatly reduced. On the other hand, the latter thermal treatment can improve the thermal shrinkage greatly, but when the effect of the imprint of projections of the surface of the backcoat layer is strong, the surface of the magnetic layer is roughened, and this causes the output to decrease and the noise to increase. In particular, a high output and low noise magnetic recording medium can be provided for the magnetic recording medium accompanying the thermal treatment. The magnetic recording medium thus obtained can be cut to a desired size using a cutter, a stamper, etc. before use.

### VIII. Physical Properties, etc.

### 1. Radiation-Cured Layer (H)

### (1) Glass Transition Temperature of the Radiation-Cured Layer (H)

In the present invention, the glass transition temperature of the radiation-cured layer (H) after curing is preferably 8000 to 15000, and more preferably 100° C. to 130° C. It is preferable if the glass transition temperature of the radiation-cured layer is in this range since there are no problems with tackiness during a coating step and the coating strength is desirable.

### (2) Modulus of Elasticity

In the present invention, the modulus of elasticity of the radiation-cured layer (H) is preferably 1 to 4 GPa, and more preferably 1.5 to 3.5 GPa. When the modulus of elasticity is in the above-mentioned range, a radiation-cured layer (H) having no problems-due to tackiness and excellent coating strength is obtained.

### (3) Average Roughness of the Radiation-Cured Layer

The average roughness (Ra) of the radiation-cured layer (H) is preferably 1 to 3 nm for a cutoff value of 0.25 nm. It is preferable if it is in this range since there are few problems with sticking to a path roller during a coating step and the magnetic layer has sufficient smoothness.

### 2. Non-Magnetic Layer/Magnetic Layer

### (1) Magnetic Layer Surface Resistance Value

In the present invention, the magnetic layer surface resistance value measured by a method in accordance with JIS X6101 is preferably 1×10⁷ Ω or less, more preferably 1×10⁶ Ω or less, and particularly preferably 1×10⁵ Ω or less. When the magnetic layer surface resistance value is in the above-mentioned range, good antistatic performance is obtained, and the adherence of dust, etc. can be prevented.

### (2) Electrostatic Potential

The electrostatic potential is preferably −500 V to +500 V.

### (3) Residual Elongation and Thermal Shrinkage

The residual elongation of the magnetic layer and the non-magnetic layer is preferably at most 0.5%. The thermal shrinkage at any temperature not exceeding 100° C. is preferably at most 1%, more preferably at most 0.5%, and yet more preferably at most 0.1%.

### (4) Glass Transition Temperature

The glass transition temperature of the magnetic layer (the maximum point of the loss modulus in a dynamic viscoelasticity measurement at 110 Hz) is preferably 50° C. to 180° C., and that of the non-magnetic layer is preferably 0° C. to 180° C. The loss modulus is preferably in the range of 1×10⁷ to 8×10⁸ Pa (1×10⁸ to 8×10⁹ dyne/cm²), and the loss tangent is preferably 0.2 or less. It is preferable if the loss tangent is 0.2 or less, since the problem of tackiness hardly occurs. These thermal properties and mechanical properties are preferably substantially identical to within 10% in each direction in the plane of the medium.

### (5) Modulus of Elasticity, Breaking Strength

The modulus of elasticity of the magnetic layer at an elongation of 0.5% is preferably 0.98 to 19.6 GPa (100 to 2,000 kg/mm²) in each direction within the plane, and the breaking strength is preferably 98 to 686 MPa (10 to 70 kg/mm²). The modulus of elasticity of the magnetic recording medium is preferably 0.98 to 14.7 GPa (100 to 1,500 kg/mm²) in each direction within the plane.

### (6) Surface Roughness of Magnetic Layer, etc.

The center plane surface roughness Ra of the magnetic layer is preferably 4.0 nm or less, more preferably 3.0 nm or less, and yet more preferably 2.0 nm or less, when measured using a TOPO-3D (manufactured by WAKO corporation). The maximum height SRmax of the magnetic layer is preferably 0.5 μm or less, the ten-point average roughness SRz is 0.3 μm or less, the center plane peak height SRp is 0.3 μm or less, the center plane valley depth SRv is 0.3 μm or less, the center plane area factor SSr is 20% to 80%, and the average wavelength Sλa is 5 to 300 μm. It is possible to set the number of surface projections on the magnetic layer having a size of 0.01 to 1 μm at any level in the range of 0 to 2,000 projections per 100 μm², and by so doing the electromagnetic conversion characteristics and the coefficient of friction can be optimized, which is preferable. They can be controlled easily by controlling the surface properties of the support by means of a filler, the particle size and the amount of a powder added to the magnetic layer, and the shape of the roll surface in the calendering process. The curl is preferably within ±3 mm.

### (7) Coefficient of Friction

The coefficient of friction of the magnetic recording medium used in the present invention with respect to a head is preferably 0.5 or less when the temperature is in the range of −10° C. to 40° C. and the humidity is in the range of 0% to 95%, and is more preferably 0.3 or less.

### (8) Saturation Magnetic Flux Density

The saturation magnetic flux density of the magnetic layer of the magnetic recording medium used in the present invention is preferably 100 to 300 mT (1,000 to 3,000 G).

### (9) Coercive Force

The coercive force (Hc) of the magnetic layer is preferably 143.3 to 318.4 kA/m (1,800 to 4,000 Oe), and more preferably 159.2 to 278.6 kA/m (2,000 to 3,500 Oe). It is preferable for the coercive force distribution to be narrow, and the SFD and SFDr are preferably 0.6 or less, and more preferably 0.2 or less.

### (10) Residual Solvent, Porosity

Residual solvent in the magnetic layer is preferably 100 mg/m² or less, and more preferably 10 mg/m² or less. The porosity of the coating layer is preferably 30 vol % or less for both the non-magnetic layer and the magnetic layer, and more preferably 20 vol % or less. In order to achieve a high output, the porosity is preferably small, but there are cases in which a certain value should be maintained depending on the intended purpose. For example, in the case of disk media where repetitive use is considered to be important, a large porosity is often preferable from the point of view of storage stability.

When the magnetic recording medium of the present invention has a non-magnetic layer and a magnetic layer, it can easily be anticipated that the physical properties of the non-magnetic layer and the magnetic layer can be varied according to the intended purpose. For example, the elastic modulus of the magnetic layer can be made high, thereby improving the storage stability, and at the same time the elastic modulus of the non-magnetic layer can be made lower than that of the magnetic layer, thereby improving the head contact of the magnetic recording medium.

A head used for playback of signals recorded magnetically on the magnetic recording medium of the present invention is not particularly limited, but an MR head is preferably used. When an MR head is used for playback of the magnetic recording medium of the present invention, the MR head is not particularly limited and, for example, a GMR head or a TMR head may be used. A head used for magnetic recording is not particularly limited, but it is preferable for the saturation magnetization to be 1.0 T or more, and more preferably 1.5 T or more.

In accordance with the present invention, a magnetic recording medium that is excellent in terms of coating smoothness, a low surface resistance value, electromagnetic conversion characteristics, error characteristics, transport durability, and storage stability can be provided.

### EXAMPLES

The present invention is explained more specifically below by reference to Examples, but the present invention should not be construed as being limited thereby. ‘Parts’ in the Examples means ‘parts by weight’ unless otherwise specified.

### Reference Example 1

Preparation of conductive polymer dispersion (E-1)

| | |
|---|---|
| In a nitrogen-flushed glove box, | 5 parts, and |
| an emeraldine base having a polystyrene-basis | |
| molecular weight of about 50,000 (undoped | |
| basic polyaniline) (PA, manufactured by Panipol) | |
| n-dodecylbenzenesulfonic acid | 26 parts |

were mixed as powders by grinding well.

This mixture was dispersed in 500 parts of toluene and subjected to ultrasonic dispersion for 48 hours. Subsequently, insolubles were removed by decantation and filtration, thus giving a toluene dispersion of polyaniline doped with n-dodecylbenzenesulfonic acid.

A portion of this toluene dispersion of polyaniline was sampled, the toluene was removed by vacuum distillation, and it was found that polyaniline was contained in the dispersion at 2.5 wt %.

A polyester support was coated with this toluene dispersion of polyaniline, dried at 100° C. for 2 minutes (toluene was distilled off), and allowed to stand at 2300 and 50% RH for 8 hours. The surface resistance value was measured and found to be 1×10⁴ Ω.

### Reference Example 2

Preparation of conductive polymer dispersion (E-2)

| | |
|---|---|
| In a nitrogen-flushed glove box, | 13 parts, and |
| an emeraldine base having a polystyrene-basis | |
| molecular weight of about 50,000 (undoped basic | |
| polyaniline) (PA, manufactured by Panipol) | |
| (±)-camphor-10-sulfonic acid | 17 parts |

were mixed as powders by grinding well.

This mixture was dispersed in 300 parts of N-methyl-2-pyrrolidone and subjected to ultrasonic dispersion for 48 hours. Subsequently, insolubles were removed by decantation and filtration, thus giving an N-methyl-2-pyrrolidone dispersion of polyaniline doped with (±)-camphor-10-sulfonic acid.

A portion of this N-methyl-2-pyrrolidone dispersion of polyaniline was sampled, the N-methyl-2-pyrrolidone was removed by vacuum distillation, and it was found that polyaniline was contained in the dispersion at 7.3 wt %. A polyester support was coated with this N-methyl-2-pyrrolidone dispersion of polyaniline, dried, and allowed to stand at 23° C. and 50% RH for 8 hours. The surface resistance value was measured and found to be 3×10⁴ Ω.

### Reference Example 3

### Preparation of Conductive Polymer Dispersion (E-3)

A separable flask reaction vessel equipped with a condenser, a stirrer, and a dropping funnel was charged with 200 parts of deionized water and 680 parts of pyrrole, a solution of 5.4 parts of potassium peroxodisulfate in 100 parts of deionized water was added dropwise thereto while stirring, and a reaction was carried out at room temperature for 24 hours. A black precipitate thus formed was collected by filtration and washed well with deionized water. It was dried in vacuum at 50° C. for 6 hours to give 100 parts of a polypyrrole powder.

| | |
|---|---|
| The polypyrrole powder | 10 parts, |
| p-toluenesulfonic acid | 10 parts, and |
| ethyl CELLOSOLVE | 170 parts |

were mixed and stirred for 12 hours to give a polypyrrole dispersion. A polyester support was coated with this polypyrrole dispersion, dried, and allowed to stand at 23° C. and 50% RH for 8 hours. The surface resistance value was measured and found to be 6×10⁴ Ω.

### Reference Example 4

### Preparation of Conductive Polymer Dispersion (E-4)

An ethanol dispersion containing 0.5% of poly(3,4-ethylenedioxythiophene) as a conductive polymer (E) and 0.8% of polystyrenesulfonic acid as a dopant was used (solids content 1.3%) (Baytron P ET V2, manufactured by Starck Ltd.). A polyester support was similarly coated with this dispersion, dried, and allowed to stand at 23° C. and 50% RH for 8 hours. The surface resistance value was measured and found to be 1×10⁴ Ω.

### Example 1

Preparation of liquid mixture for radiation-cured layer (H)

| | |
|---|---|
| The conductive polymer (E) dispersion (E-1, | 10 parts, |
| as effective components including dopant) | |
| 1,4-butanediol diacrylate | 90 parts, and |
| toluene (including the toluene in the conductive | 400 parts |
| polymer (E) dispersion) | |

were mixed and stirred for 20 minutes, and filtered using a filter having an average pore size of 1 μm, thus giving a liquid mixture for the radiation-cured layer (H).

Preparation of magnetic layer coating solution

| | |
|---|---|
| 100 parts of ferromagnetic alloy powder A (composition: Co 20%, Al 9%, | |
| and Y 6% relative to 100 atom % Fe; Hc 175 kA/m; crystallite size 11 nm; BET | |
| specific surface area 70 m²/g; major axis length 45 nm; σs 111 emu/g) was ground | |
| in an open kneader for 10 minutes, and then kneaded for 60 minutes with | |
| a 30% cyclohexanone solution of a vinyl chloride-based copolymer (MR110, | 30 parts, and |
| manufactured by Nippon Zeon Corporation) | |
| a 30% MEK/toluene = 1/1 solution of a polyurethane resin (UR8200, | 30 parts. |
| manufactured by Toyobo Co., Ltd.) | |
| To this were added | |
| α-alumina (HIT55, manufactured by Sumitomo Chemical Co., Ltd.) | 10 parts |
| carbon black (#50, manufactured by Asahi Carbon Co., Ltd.) | 3 parts, and |
| MEK/toluene = 1/1 | 200 parts, |
| and the mixture was dispersed in a sand mill for 120 minutes. | |
| To this were added | |
| a 30% MEK/toluene = 1/1 solution of a polyisocyanate (Coronate 3041, | 15 parts |
| manufactured by Nippon Polyurethane Industry Co., Ltd.) | |
| stearic acid | 1 part |
| myristic acid | 1 part |
| isohexadecyl stearate | 3 parts, and |
| MEK | 100 parts, |

and after stirring the mixture for a further 20 minutes, it was filtered using a filter having an average pore size of 1 μm to give a magnetic layer coating solution.

Preparation of non-magnetic layer coating solution

| | |
|---|---|
| 85 parts of acicular α-iron oxide (major axis length 100 nm; alumina surface | |
| treatment layer; BET specific surface area 52 m²/g; pH 9.4) and 15 parts of carbon | |
| black (Ketjen Black EC, manufactured by Ketjen Black International) were ground | |
| in an open kneader for 10 minutes, and then kneaded for 60 minutes with | |
| a 30% cyclohexanone solution of a vinyl chloride-based copolymer (MR110, | 30 parts, and |
| manufactured by Nippon Zeon Corporation) | |
| a 30% MEK/toluene = 1/1 solution of a polyurethane resin (UR8200, | 30 parts. |
| manufactured by Toyobo Co., Ltd.) | |
| Subsequently, | |
| MEK/cyclohexanone = 6/4 | 200 parts |
| was added, and the mixture was dispersed in a sand mill for 120 minutes. | |
| To this were added | |
| a 30% MEK/toluene = 1/1 solution of a polyisocyanate (Coronate 3041, | 15 parts |
| manufactured by Nippon Polyurethane Industry Co., Ltd.) | |
| stearic acid | 1 part |
| myristic acid | 1 part |
| isooctyl stearate | 3 parts, and |
| MEK | 50 parts, |

and after stirring the mixture for a further 20 minutes, it was filtered using a filter having an average pore size of 1 μm to give a non-magnetic layer coating solution.

The surface of a polyethylene naphthalate support (thickness 7 μm, center average surface roughness Ra 6.2 nm) was coated by means of a wire-wound bar with the liquid mixture for the radiation-cured layer (H) so that the dry thickness would be 0.5 μm, then dried at 100° C. for 90 sec., and cured by irradiation with an electron beam at an acceleration voltage of 100 kV so as to give an absorbed dose of 10 kGy (1 Mrad) under an atmosphere having an oxygen concentration of 200 ppm or less. Sampling was carried out at this point; the sample was allowed to stand at 23° C. and 50% RH for 8 hours, and the surface resistance value was measured and found to be 8×10⁴ Ω, which was good.

Subsequently, using reverse roll simultaneous multilayer coating, the non-magnetic coating solution was applied on top of the radiation-cured layer and the magnetic coating solution was applied on top of the non-magnetic coating solution so that the dry thicknesses would be 1.0 μm and 0.1 μm respectively. Before the magnetic coating solution had dried, it was subjected to magnetic field alignment using a 0.5 T (5,000 G) Co magnet and a 0.4 T (4,000) G solenoid magnet, the solvent was dried off, and the coating was then subjected to a calender treatment employing a metal roll-metal roll-metal roll-metal roll-metal roll-metal roll-metal roll combination (speed 100 m/min, line pressure 300 kg/cm, temperature 90° C.) and further to a thermal treatment at 50° C. for 7 days, and then slit to a width of 3.8 mm.

### Examples 2 to 4

The procedure of Example 1 was repeated except that the conductive polymer (E-1) was changed to (E-2) to (E-4).

### Examples 5 to 17

The procedure of Example 1 was repeated except that the conditions were changed as shown in Table 1.

### Comparative Example 1

The procedure of Example 1 was repeated except that the radiation-cured layer (H) comprising the conductive polymer (E-1) was not applied, and the thickness of the non-magnetic layer was changed from 1.0 μm to 1.5 μm.

### Comparative Example 2

The procedure of Example 1 was repeated except that the conductive polymer (E-1) was not applied.

### Comparative Example 3

The procedure of Example 1 was repeated except that the entire amount (100 parts) of the radiation-cured layer (H) was the conductive polymer (E-1).

### Measurement Methods

### (1) Measurement of Thickness of Radiation-Cured Layer (H)

5 sections of magnetic recording medium were prepared, the thickness of the radiation-cured layer in each section was measured using a transmission electron microscope (TEM), and an average value thereof was calculated and defined as the thickness of the radiation-cured layer.

### (2) Modulus of Elasticity of Radiation-Cured Layer (H)

A sample obtained by coating a polyethylene naphthalate support with a liquid mixture for the radiation-cured layer (H), followed by drying and further curing with an electron beam, and the support on its own, were subjected to a tensile test at 23° C., and a tensile modulus of elasticity of the radiation-cured layer (H) was determined from the difference between the two.

### (3) Surface Resistance Value

A measurement was carried out by a method in accordance with JIS X6101 using a TR-8611A manufactured by Advantest Corporation.

### (4) Magnetic Layer Surface Roughness Ra

A center line average roughness Ra was measured by an optical interference method using a digital optical profiler (manufactured by Wyko Corporation) under conditions of a cutoff value of 0.25 mm.

### (5) Adhesion

Double-sided adhesive tape was affixed to a glass plate, a tape sample was affixed thereto so that the magnetic layer side was in contact with the adhesive tape and peeled off by a 180° peel-off method, and the peel strength was measured using a spring scale.

### (6) Electromagnetic Conversion Characteristics

A single frequency signal at 4.7 MHz was recorded at an optimum recording current using a DDS3 drive, and the playback output thereof was measured and expressed as a relative value where the playback output of Comparative Example 1 was 0 dB.

### (7) Error Count

One 90 m long track was played back using the above-mentioned magnetic recording/playback system, and the number of times an error occurred was measured, defining an output fall of 35% or greater for a length of 4 bits or greater as a signal defect.

### (8) Transport Durability

Head contamination was inspected after repeating 1,000 passes of a 1 minute length of a tape in the DDS3 drive of (6) above at 40° C. and 30% RH; when there was no contamination, the result was evaluated as A, when there was slight contamination the result was evaluated as B, and when there was contamination the result was evaluated as C. After transport, the tape edge was inspected; when cracks were seen to have occurred the result was evaluated as B, when the magnetic layer was lost from the cracked part the result was evaluated as C, and when there were no cracks and no loss the result was evaluated as A.

### (9) Storage Stability

A tape that had been stored for one week in an environment of 60° C. and 90% RH was transported under the same conditions as above, and head contamination was inspected; when there was no contamination, the result was evaluated as A, when there was slight contamination the result was evaluated as B, and when there was contamination the result was evaluated as C.

The evaluation results for Examples 1 to 17 and Comparative Examples 1 to 3 are shown in Table 1 below. The radiation curing monomers are abbreviated as follows. BDDA denotes 1,4-butanediol diacrylate, TMTA denotes trimethylolpropane triacrylate, PETA denotes pentaerythritol tetraacrylate, EBPA denotes 2-ethyl-2-butyl-1,3-propanediol diacrylate, UR denotes a urethane diacrylate formed by condensation of trimethylhexamethylene diusocyanate and hydroxyethyl acrylate, and TCDA denotes tricyclodecanedimethanol diacrylate.

TABLE 1

| | Conductive | | Radiation | | | | | Non- | | | |
|---|---|---|---|---|---|---|---|---|---|---|---|
| | polymer | | curing | | Radiation-cured | | | magnetic | | | |
| | (E) | | monomer (C) | | layer (H) | | | layer | Magnetic layer | | |
| | | Parts | | Parts | Thick- | Modulus of | Surface | Thick- | Thick- | Surface | Surface |
| | | (sol- | | (sol- | ness | elasticity | resistance | ness | ness | roughness | resistance |
| | Type | ids) | Type | ids) | (μm) | (Gpa) | (Ω) | (μm) | (μm) | Ra (nm) | (Ω) |
| Ex. 1 | (E-1) | 10 | BDDA | 90 | 0.5 | 2.6 | 8 × 10⁴ | 1.0 | 0.1 | 2.0 | 1 × 10⁶ |
| Ex. 2 | (E-2) | 10 | BODA | 90 | 0.5 | 2.6 | 3 × 10⁵ | 1.0 | 0.1 | 2.0 | 5 × 10⁶ |
| Ex. 3 | (E-3) | 10 | BODA | 90 | 0.5 | 2.5 | 8 × 10⁵ | 1.0 | 0.1 | 2.5 | 9 × 10⁶ |
| Ex. 4 | (E-4) | 10 | BDDA | 90 | 0.5 | 2.6 | 9 × 10⁴ | 1.0 | 0.1 | 2.1 | 2 × 10⁶ |
| Ex. 5 | (E-1) | 10 | TMTA | 90 | 0.5 | 2.8 | 9 × 10⁴ | 1.0 | 0.1 | 2.0 | 2 × 10⁶ |
| Ex. 6 | (E-1) | 10 | PETA | 90 | 0.5 | 2.9 | 7 × 10⁴ | 1.0 | 0.1 | 2.0 | 1 × 10⁶ |
| Ex. 7 | (E-1) | 10 | EBPA | 90 | 0.5 | 2.6 | 7 × 10⁴ | 1.0 | 0.1 | 2.1 | 1 × 10⁶ |
| Ex. 8 | (E-1) | 10 | UR | 90 | 0.5 | 2.8 | 6 × 10⁴ | 1.0 | 0.1 | 2.2 | 1 × 10⁶ |
| Ex. 9 | (E-1) | 10 | TCDA | 90 | 0.5 | 2.6 | 9 × 10⁴ | 1.0 | 0.1 | 1.9 | 3 × 10⁶ |
| Ex. 10 | (E-1) | 5 | BDDA | 95 | 0.5 | 2.7 | 1 × 10⁵ | 1.0 | 0.1 | 1.9 | 2 × 10⁶ |
| Ex. 11 | (E-1) | 25 | BDDA | 75 | 0.5 | 2.3 | 7 × 10⁴ | 1.0 | 0.1 | 2.2 | 9 × 10⁵ |
| Ex. 12 | (E-1) | 50 | BDDA | 50 | 0.5 | 1.8 | 4 × 10⁴ | 1.0 | 0.1 | 2.3 | 5 × 10⁵ |
| Ex. 13 | (E-1) | 75 | BDDA | 25 | 0.5 | 1.4 | 2 × 10⁴ | 1.0 | 0.1 | 2.5 | 5 × 10⁵ |
| Ex. 14 | (E-1) | 10 | BDDA | 90 | 0.5 | 2.6 | 8 × 10⁴ | — | 0.1 | 1.7 | 1 × 10⁵ |
| Ex. 15 | (E-1) | 10 | BODA | 90 | 0.3 | 2.6 | 9 × 10⁴ | 1.0 | 0.1 | 2.6 | 3 × 10⁶ |
| Ex. 16 | (E-1) | 10 | BDDA | 90 | 0.8 | 2.6 | 8 × 10⁴ | 1.0 | 0.1 | 1.9 | 8 × 10⁵ |
| Ex. 17 | (E-1) | 10 | BODA | 90 | 1.4 | 2.6 | 8 × 10⁴ | 1.0 | 0.1 | 1.7 | 8 × 10⁵ |

| Comp. Ex. 1 | — | — | | — | | | 1.5 | 0.1 | 3.4 | 3 × 10⁸ |
|---|---|---|---|---|---|---|---|---|---|---|
| Comp. Ex. 2 | — | BDDA | 100 | 0.5 | 2.8 | 5 × 10¹² | 1.0 | 0.1 | 1.9 | 4 × 10¹² |

| | | | | | | | | | | |
|---|---|---|---|---|---|---|---|---|---|---|
| Comp. Ex. 3 | (E-1) | 100 | — | 0.5 | 0.9 | 1 × 10⁴ | 1.0 | 0.1 | 2.6 | 2 × 10⁵ |

| | | Electro- | | | | |
|---|---|---|---|---|---|---|
| | | magnetic | | Transport | | |
| | | conversion | | durability | | Storage |
| | | characteristics | Frequency | Head | | stability (head |
| | Adhesion | C/N | of errors | contam- | Edge | contamination |
| | (gf) | (dB) | (times) | ination | damage | after storage) |
| Ex. 1 | 155 | 1.9 | 25 | A | A | A |
| Ex. 2 | 160 | 1.8 | 31 | A | A | A |
| Ex. 3 | 150 | 1.6 | 40 | A | A | A |
| Ex. 4 | 150 | 1.9 | 26 | A | A | A |
| Ex. 5 | 130 | 1.8 | 27 | A | A | A |
| Ex. 6 | 160 | 1.8 | 24 | A | A | A |
| Ex. 7 | 155 | 1.8 | 30 | A | A | A |
| Ex. 8 | 160 | 1.8 | 26 | A | A | A |
| Ex. 9 | 140 | 1.9 | 24 | A | A | A |
| Ex. 10 | 170 | 2.1 | 30 | A | A | A |
| Ex. 11 | 160 | 1.9 | 24 | A | A | A |
| Ex. 12 | 130 | 1.7 | 24 | A | A | A |
| Ex. 13 | 110 | 1.4 | 30 | B | B | B |
| Ex. 14 | 160 | 2.3 | 21 | A | A | A |
| Ex. 15 | 160 | 1.3 | 33 | A | A | A |
| Ex. 16 | 155 | 2.1 | 26 | A | A | A |
| Ex. 17 | 90 | 2.1 | 26 | A | A | A |
| Comp. Ex. 1 | 15 | 0 | 72 | A | C | A |
| Comp. Ex. 2 | 180 | 2.1 | 355 | C | B | C |
| Comp. Ex. 3 | 45 | 1.4 | 34 | C | C | C |

### Results of Examples

The magnetic recording medium (Comparative Example 1) not comprising the radiation-cured layer (H) had a high surface roughness, edge damage occurred after the transport durability test, and the frequency of errors was not satisfactory. Although the surface resistance value varied depending on the type of conductive polymer (E), it was possible to use various types of conductive polymer (E). Among them, polyaniline (E-1) was preferable.

The amount of conductive polymer (E) added to the radiation-cured layer (H) did not greatly affect the performance, but when it was not added (Comparative Example 2) the surface resistance value was high, dust, etc. adhered, and as a result head contamination was caused and errors occurred. The magnetic recording medium of Comparative Example 3, which did not comprise the radiation curing monomer (C) unit at all, could not satisfy all of the above items.

From the above results, the magnetic recording medium comprising, over a non-magnetic support, the radiation-cured layer (H) formed by curing a layer comprising the conductive polymer (E) and the radiation curing monomer (C) by exposure to radiation was excellent in terms of coating smoothness, a low surface resistance value, electromagnetic conversion characteristics, error characteristics, transport durability, and storage stability.

What is claimed is:

1. A magnetic recording medium comprising:
a non-magnetic support and, in order thereabove;
a radiation-cured layer (H) cured by exposing a layer comprising a conductive polymer (E) and a radiation curing monomer (C) to radiation; and
a magnetic layer comprising a ferromagnetic powder dispersed in a binder.

2. The magnetic recording medium according to claim 1, wherein the magnetic recording medium comprises, between the radiation-cured layer (H) and the magnetic layer, a non-magnetic layer comprising a non-magnetic powder dispersed in a binder.

3. The magnetic recording medium according to claim 1, wherein the radiation-cured layer (H) comprises a dopant.

4. The magnetic recording medium according to claim 1, wherein the conductive polymer (E) is a π-electron conjugated polymer.

5. The magnetic recording medium according to claim 4, wherein the π-electron conjugated polymer is at least one π-electron conjugated polymer selected from the group consisting of polythiophene, polypyrrole, polyaniline, polyfuran, polyacetylene, polyp-phenylene), poly(p-phenylenesulfide), and derivatives thereof.

6. The magnetic recording medium according to claim 3, wherein the conductive polymer (E) is polypyrrole and/or a polypyrrole derivative, and the dopant is at least one dopant selected from the group consisting of 2,3-dichloro-5,6-dicyano-1,4-benzoquinone (DDQ), 7,7,8,8-tetracyanoquinodimethane (TCNQ), tetracyanoethylene (TCNE), chloranil, tetrafluorotetracyanoquinodimethane (TF-TCNQ), a DAMN derivative (tetracyanopyrazine, tetracyanotetraazanaphthalene, etc.), p-toluenesulfonic acid, dodecylbenzenesulfonic acid, and polystyrenesulfonic acid.

7. The magnetic recording medium according to claim 3, wherein the conductive polymer (E) is at least one π-electron conjugated polymer selected from the group consisting of polyaniline, a polyaniline derivative, polythiophene, and a polythiophene derivative, and the dopant is at least one dopant selected from the group consisting of sulfuric acid, nitric acid, hydrochloric acid, perchloric acid, hydrofluoric acid, phosphoric acid, oxalic acid, formic acid, acetic acid, acrylic acid, methacrylic acid, benzenesulfonic acid, p-toluenesulfonic acid, trifluoroacetic acid, p-dodecylbenzenesulfonic acid, n-dodecylbenzenesulfonic acid, picric acid, m-nitrobenzoic acid, dichloroacetic acid, an alkylsulfonic acid, an alkyl-substituted naphthalenesulfonic acid, (±)-camphor-10-sulfonic acid, an alkyl phosphate, polystyrenesulfonic acid, polyacrylic acid, polymethacrylic acid, polyvinylsulfonic acid, polyallylsulfonic acid, and polyphosphoric acid.

8. The magnetic recording medium according to claim 3, wherein the combination of the conductive polymer (E) and the dopant is at least one combination selected from the group consisting of the combinations polyaniline and n-dodecylbenzenesulfonic acid, undoped basic polyaniline and (±)-camphor-10-sulfonic acid, polypyrrole powder and p-toluenesulfonic acid, and poly(3,4-ethylenedioxythiophene) and polystyrenesulfonic acid.

9. The magnetic recording medium according to claim 1, wherein the radiation-cured layer (H) has an average thickness of 0.1 to 1.5 km.

10. The magnetic recording medium according to claim 1, wherein the conductive polymer (E), including dopant, is contained at 1 to 80 parts by weight in 100 parts by weight of the solids content of the radiation-cured layer (H).

11. The magnetic recording medium according to claim 1, wherein the conductive polymer (E), including dopant, is contained at 5 to 50 parts by weight in 100 parts by weight of the solids content of the radiation-cured layer (H).

12. The magnetic recording medium according to claim 1, wherein the radiation curing monomer (C) is a polyfunctional (meth)acrylate obtained by reacting a polyhydric alcohol with (meth)acrylic acid and/or a polyfunctional urethane (meth)acrylate obtained by reacting a polyvalent isocyanate compound with hydroxyethyl (meth)acrylate.

13. The magnetic recording medium according to claim 1, wherein the radiation curing monomer (C) is a polyfunctional acrylate obtained by reacting a polyhydric alcohol with acrylic acid and/or a polyfunctional urethane acrylate obtained by reacting a polyvalent isocyanate compound with hydroxyethyl acrylate.

14. The magnetic recording medium according to claim 1, wherein the radiation curing monomer (C) is at least one radiation curing monomer selected from the group consisting of 1,4-butanediol diacrylate, trimethylolpropane triacrylate, pentaerythritol tetraacrylate, 2-ethyl-2-butyl-1,3-propanediol diacrylate, tricyclodecanedimethanol diacrylate, and a urethane diacrylate obtained by condensing trimethylhexamethylene diisocyanate and hydroxyethyl acrylate.

15. The magnetic recording medium according to claim 1, wherein the non-magnetic support is a non-magnetic support selected from the group consisting of polyethylene terephthalate, polyethylene naphthalate, polyamide, polyamideimide, and an aromatic polyamide.

16. The magnetic recording medium according to claim 1, wherein the non-magnetic support is polyethylene naphthalate.
